(19) United States
(12) Patent Application Publication
(10) Pub. No.: US 2024/0265441 A1
(43) Pub. Date: Aug. 8, 2024

(54) METHOD OF PROVIDING A RESIDENTIAL NET LEASE NETWORK WITH A CREDIT ENHANCEMENT MODULE

(71) Applicant: Capview Partners, LLC, Dallas, TX (US)

(72) Inventors: John Hammill, Dallas, TX (US); Kevin Connelly, Dallas, TX (US); Danilo da Silva, Dallas, TX (US)

(21) Appl. No.: 18/418,166

(22) Filed: Jan. 19, 2024

Related U.S. Application Data
(60) Provisional application No. 63/440,295, filed on Jan. 20, 2023.

(51) Int. Cl. G06Q 40/03; G06Q 30/0645

(52) U.S. Cl. CPC G06Q 40/03; G06Q 30/0645

(57) ABSTRACT

The present disclosure provides a method of credit enhancement for residential net leases to predict that a residential net lease tenant may qualify as an investment grade tenant based on accounting of a backstop database that backstops a single reserve database. The credit enhancement ensures calculations are sufficiently back-tested that the amount will withstand the volatility of the rental market and keep the residential net lease in a credit-worthy state based on an enhancement module that initializes stress scenarios.

### CROSS-REFERENCE TO RELATED APPLICATIONS

This application claims priority from U.S. provisional application 63/440,295 filed Jan. 20, 2023, the disclosure of which is incorporated herein by reference.

### FIELD OF THE DISCLOSURE

The present disclosure is generally related to providing credit enhancement for residential net leases.

### FIELD OF THE DISCLOSURE

The present disclosure is generally related to providing and managing residential net lease network with a credit enhancement module.

### BACKGROUND

It is difficult to determine the amount required for a residential net lease tenant to ensure that a lease can be covered in the event of unexpected financial situations. Also, there is a need to determine an amount needed in reserves to ensure that a provider of the residential net lease remains in good standing to increase the provider's credit quality to an investment grade level. Lastly, it is time-consuming and difficult for landlords and property owners to perform sufficient background checks on potential tenants. Once the tenant signs a rental agreement, there are no systems in place to continuously monitor the tenant's financial stability. There is currently no means for a system that offers residential net leases to property owners to ensure that the tenant will make the rental payments, especially in a time of financial instability.

### SUMMARY

Disclosed are systems, apparatuses, methods, computer readable medium, and circuits for automating a residential net lease management tool with a credit enhancement module. According to at least one example, a method includes receiving, over an expense network, market data associated with a specific region sent over a communication network at a net lease management server configured to communicate with at least one third-party application. A net lease module may initiate a reserve module. The reserve module may generate net lease parameters for the specific region based on a calculated profitability evaluation based on the market data received via the expense network, wherein the calculated profitability evaluation determines a threshold margin based on a percentage of an average rental rate and average fixed costs in the specific region.

In some cases, the method includes the net lease module initiating an owner module. The owner module may identity properties that fall within the net lease parameters generated by the reserve module. The net lease module may initiate a manage module. The manage module may determine fixed costs and variable costs based on data associated with at least one of the identified properties and extracted data points from stored invoice data. The reserve module may generate a set of net lease terms associated with the at least one of the properties identified by the net lease module, based on inputs including the fixed costs and variable costs determined the manage module, wherein weights are assigned to each input.

In some cases, the method includes the net lease module initiating an enhancement module. The enhancement module may generate one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios. The enhancement module may determine that a backstop database to the single reserve database does not have a sufficient backstop amount to cover the multiplier of the predicted amount based on results of the stress scenario. Based upon the determination and over the communication network, an instruction to trigger a transfer of a difference between the sufficient backstop amount and an accounting at the backstop database to the backstop database may be sent.

In another example, a system for automating a residential net lease management tool with a credit enhancement module is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the system to receive, over an expense network, market data associated with a specific region sent over a communication network at a net lease management server configured to communicate with at least one third-party application. A net lease module may initiate a reserve module. The reserve module may generate net lease parameters for the specific region based on a calculated profitability evaluation based on the market data received via the expense network, wherein the calculated profitability evaluation determines a threshold margin based on a percentage of an average rental rate and average fixed costs in the specific region.

In some cases, the instructions cause the system to initiate an owner module. The owner module may identity properties that fall within the net lease parameters generated by the reserve module. The net lease module may initiate a manage module. The manage module may determine fixed costs and variable costs based on data associated with at least one of the identified properties and extracted data points from stored invoice data. The reserve module may generate a set of net lease terms associated with the at least one of the properties identified by the net lease module, based on inputs including the fixed costs and variable costs determined the manage module, wherein weights are assigned to each input.

In some cases, the instructions cause the system to initiate an enhancement module. The enhancement module may generate one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios. The enhancement module may determine that a backstop database to the single reserve database does not have a sufficient backstop amount to cover the multiplier of the predicted amount based on results of the stress scenario. Based upon the determination and over the communication network, an instruction to trigger a transfer of a difference between the sufficient backstop amount and an accounting at the backstop database to the backstop database may be sent.

### BRIEF DESCRIPTION OF THE SEVERAL VIEWS OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

### BRIEF DESCRIPTIONS OF THE DRAWINGS

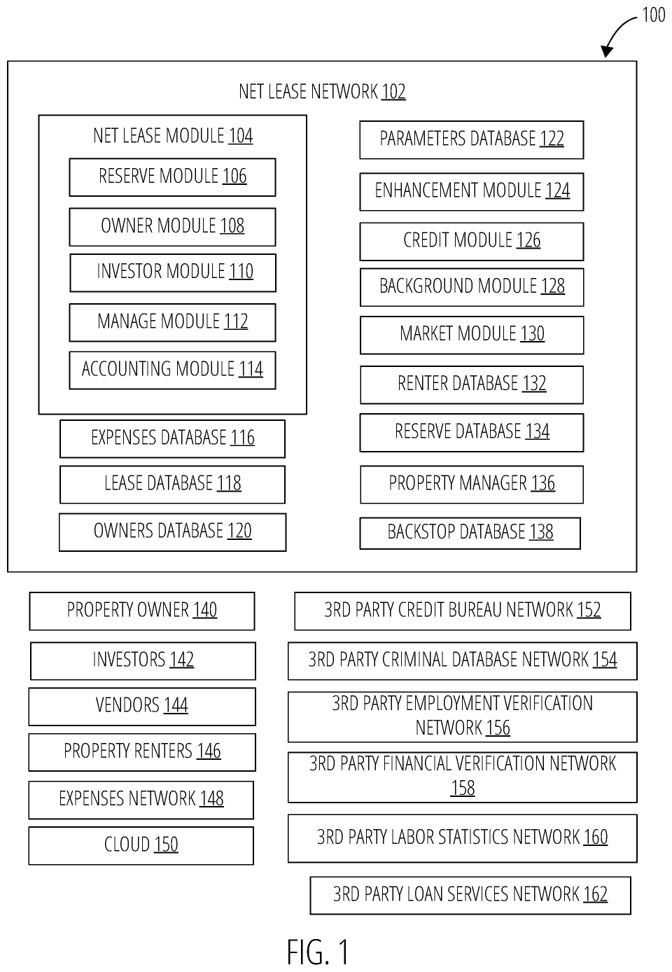

FIG. 1 illustrates a system for providing a method of providing a residential net lease network with a credit enhancement module.

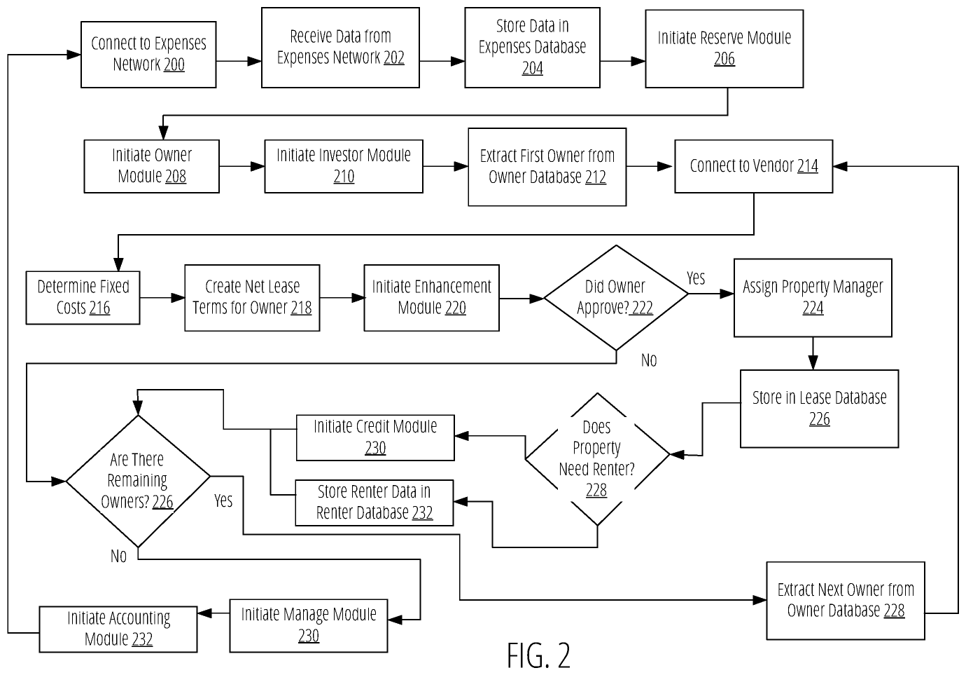

FIG. 2 illustrates an example method performed by a net lease module.

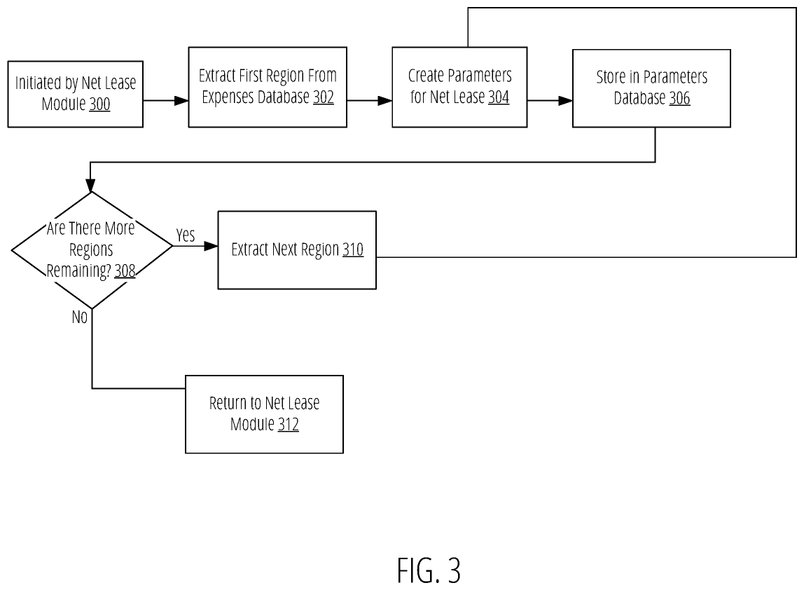

FIG. 3 illustrates an example method performed by a reserve module.

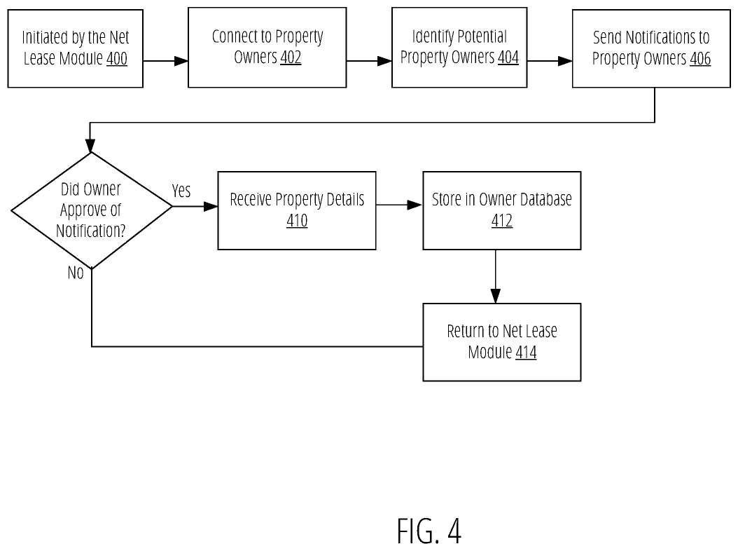

FIG. 4 illustrates an example method performed by an owner module.

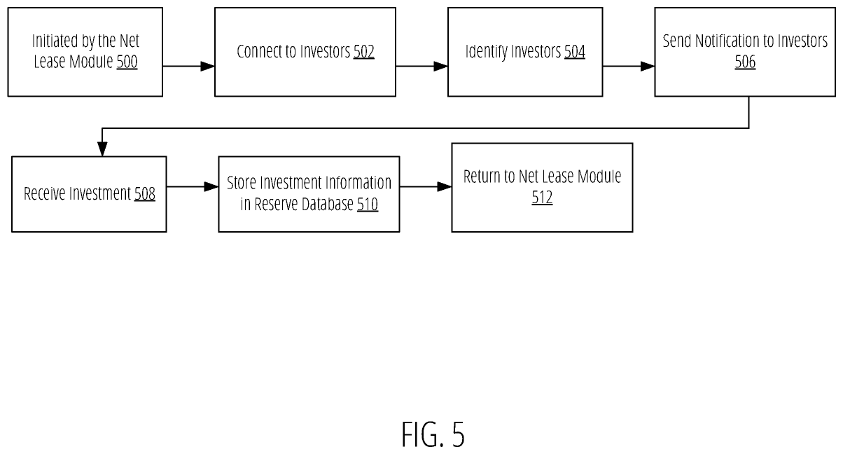

FIG. 5 illustrates an example method performed by an investor module.

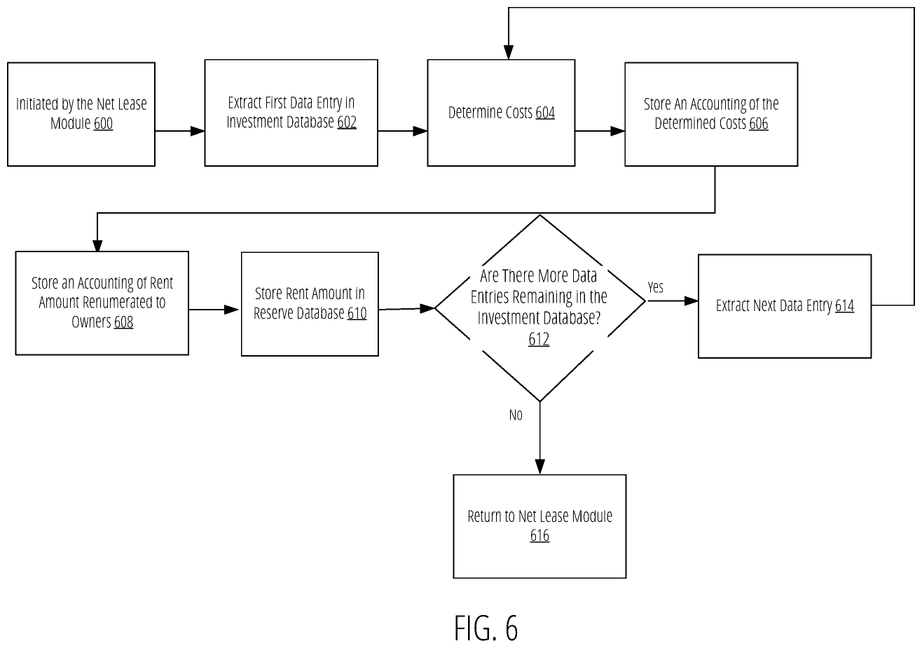

FIG. 6 illustrates an example method performed by a manage module.

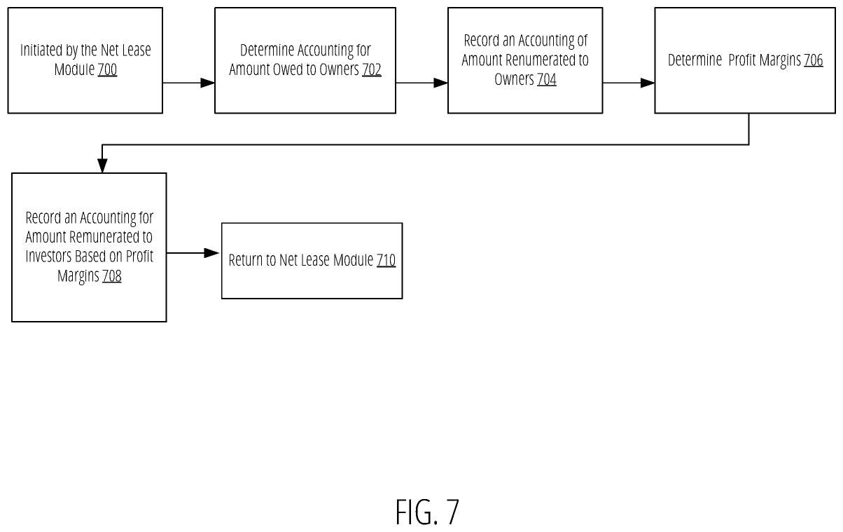

FIG. 7 illustrates an example method performed by an accounting module.

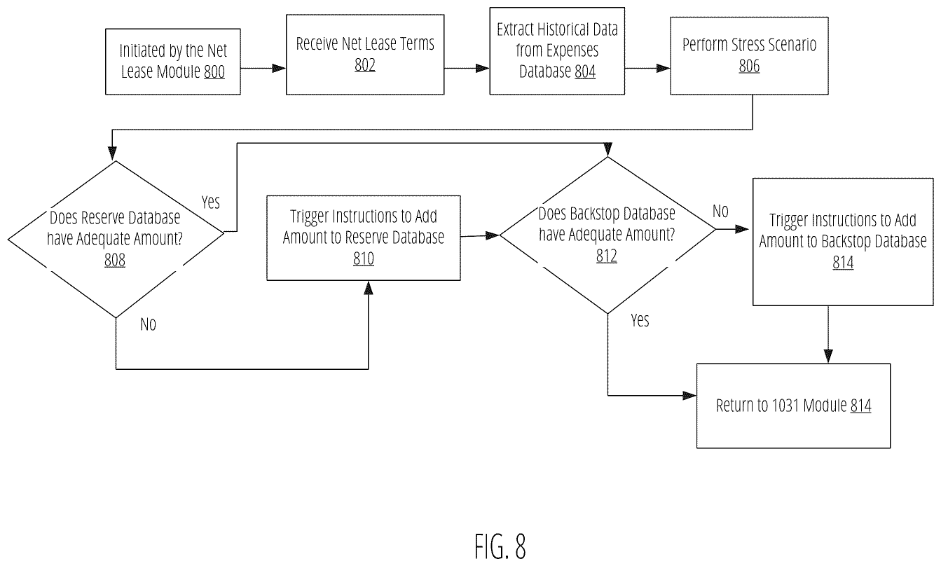

FIG. 8 illustrates an example method performed by an enhancement module.

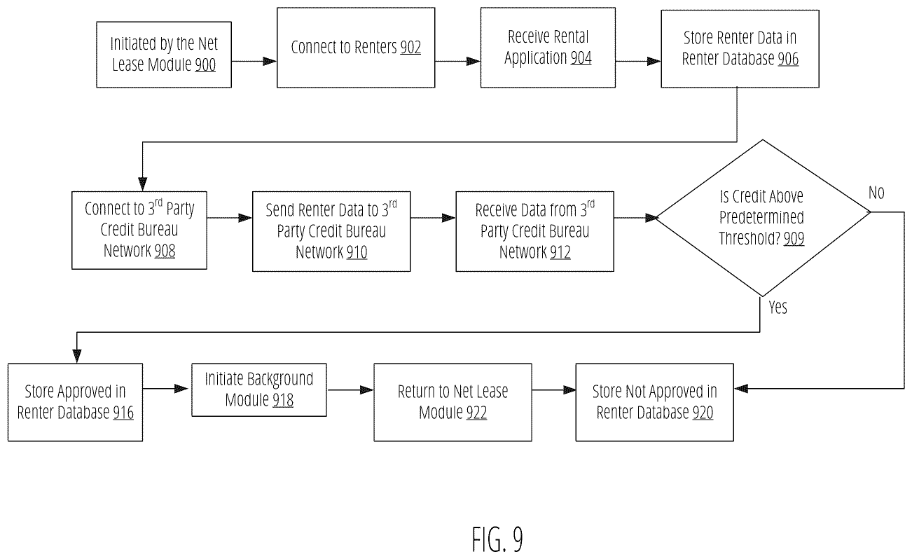

FIG. 9 illustrates an example method performed by a credit module.

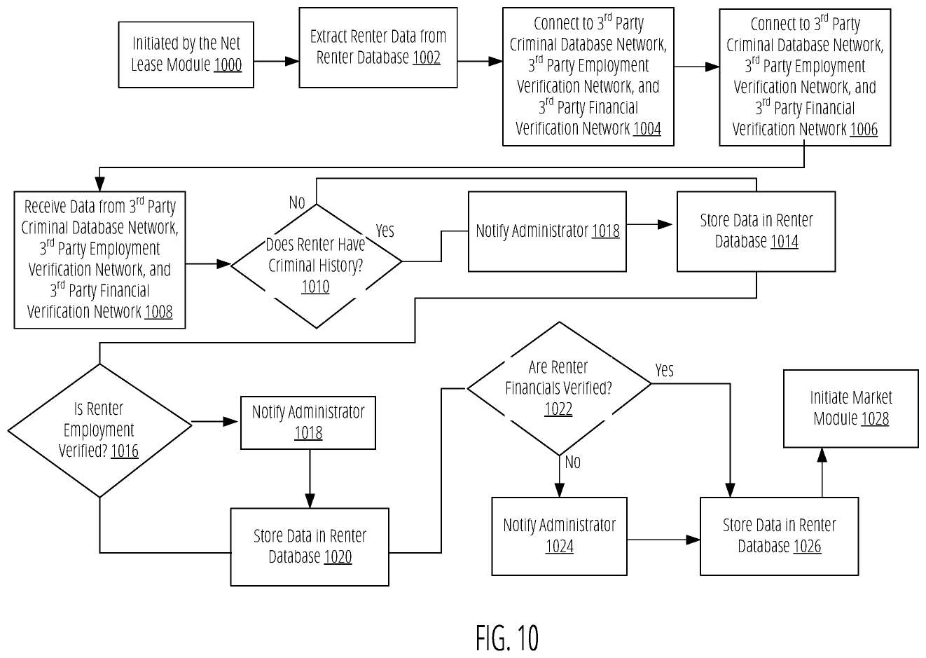

FIG. 10 illustrates an example method performed by a background module.

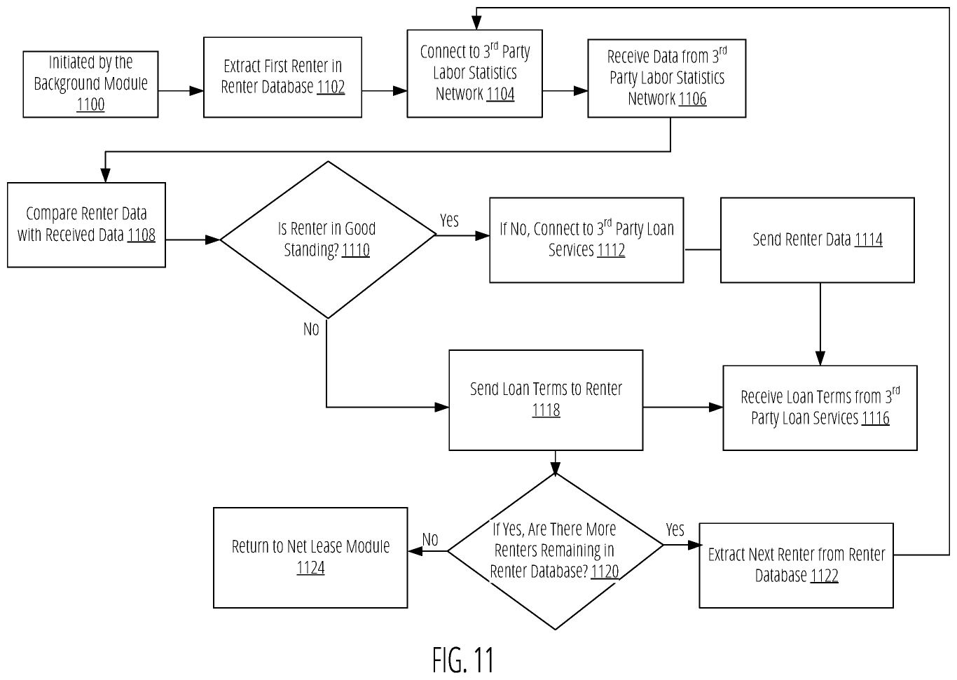

FIG. 11 illustrates an example method performed by a market module.

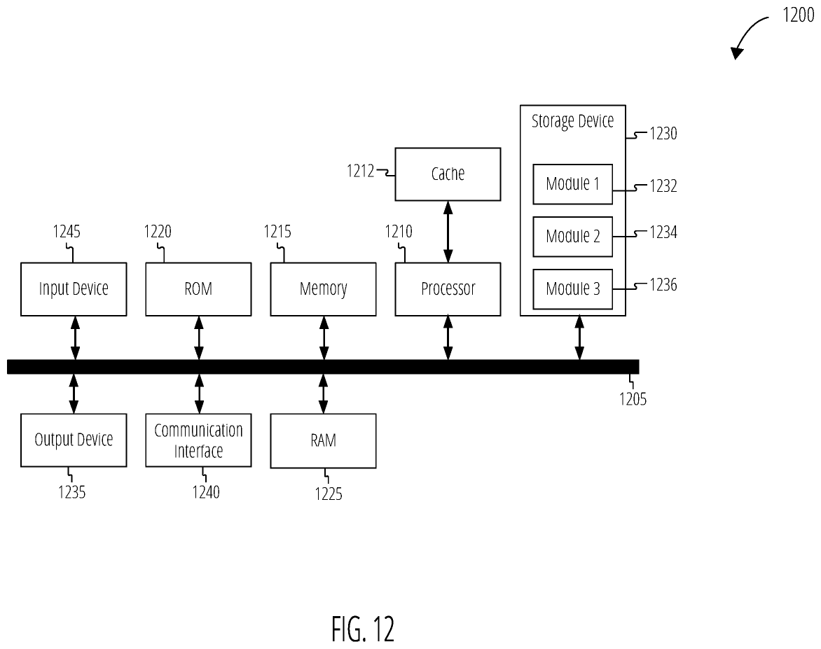

FIG. 12 shows an example system for providing a residential net lease network with a credit enhancement module.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

FIG. 1 illustrates a system for providing a method of providing a residential net lease network with a credit enhancement module.

The present disclosure relates to a system and method for providing a residential net lease network with a credit enhancement module, with a focus on providing residential net leases as a part of the exchange. The credit enhancement module may serve to monitor a backstop database that retains an accounting based on a determined multiplier of predicted future expenses calculated based on historical trend data that impact the fixed costs and variable costs associated with rental properties. In some cases, the multiplier and the predicted future expense are calculated based on one or more stress scenarios that select the predicted amount between an upper bound and a lower bound and a multiplier between a multiplier upper bound and a multiplier lower bound based on the extracted historical data. In some cases, the multiplier and the predicted future expenses may be calculated by a machine-learning model that trains and retrains on historical and real-time data such that the multiplier and the predicted future expenses are more accurately attuned to a changing economy.

A net lease system 100 may comprise a net lease network 102, which may be a software system or process to calculate a long-term, net lease amount to property owners 140 of residential rental properties for a 15 to 25-year primary term and provides landlords with more net operating income for the first five to nine years in exchange for an up-front initial lease reserve amount that in combination with rents received from renters, allows the lessee to absorb all property level expenses and meet the agreed terms of the lease and make all net lease amounts.

The absolute net lease means that the lessee pays the landlord (lessor) a fixed lease amount with annual escalations according to a lease amount schedule in exchange for full control and uninterrupted rights to the property as if it were owned by the lessee for the period of the primary lease term and any renewal options it executes. These rights include the right to rent the property to sub-tenants/renters to generate rental income. The lessee is responsible for all property-level expenses including, but not limited to, taxes, insurance, maintenance, utilities, capital expenditures, replacement and repair of FF&E and real property, management, etc. Further, embodiments may include a net lease module 104, which begins by connecting to the expenses network 148.

The net lease module 104 receives the data from the expenses network 148. The net lease module 104 stores the data from the expenses network 148 in the expenses database 116. The net lease module 104 initiates the reserve module 106. The net lease module 104 initiates the owner module 108. The net lease module 104 initiates the investor module 110. The net lease module 104 extracts the first owner from the owners database 120. The net lease module 104 connects to the vendors 144. The net lease module 104 determines the fixed and variable costs for the property. The net lease module 104 creates the net lease terms for the property owner. The net lease module 104 determines if the property owner 140 approved the net lease terms.

In some cases, a machine-learning model is used to output the set of net lease terms. The machine-learning model may determine the weights based on training data including past net lease terms associated with the one or more regions.

If it is determined that the property owner 140 approved the net lease terms, the net lease module 104 assigns a property manager 136 to the property. The net lease module 104 stores the data in the lease database 118. If it is determined that the property owner 140 did not approve of the net lease terms or after the data is stored in the lease database 118, the net lease module 104 determines if there are any property owners 140 remaining in the owners database 120. If it is determined that more owners are remaining in the owners database 120, the net lease module 104 extracts the next owner from the owners database 120, and the method returns to connecting to the vendors 144. If it is determined that there are no more owners remaining in the owners database 120, the net lease module 104 initiates the manage module 112. Then, the net lease module 104 initiates the accounting module 114, and the method returns to connecting to the expenses network 148.

Further, embodiments may include a reserve module 106, which begins by being initiated by the net lease module 104. The reserve module 106 extracts the first region from the expenses database 116. The reserve module 106 creates the parameters for the net lease for the region. The reserve module 106 stores the parameters in the parameters database 122. The reserve module 106 determines if there are any more regions remaining in the expenses database 116. If it is determined that there are more regions remaining in the expenses database 116, the reserve module 106 extracts the next region from the expenses database 116, and the method returns to creating the parameters for the net lease for the region. If it is determined that there are no more regions remaining in the expenses database 116, the reserve module 106 returns to the net lease module 104.

Further, embodiments may include an owner module 108, which begins by being initiated by the net lease module 104. The owner module 108 connects to the property owners 140. The owner module 108 identifies the potential property owners that may have a property that is within the parameters for a net lease. The owner module 108 sends a notification to the property owners 140 that have a property that fulfills the parameters for a net lease. The owner module 108 determines if the owner approved the notification. If the owner approves the notification the owner module 108 receives the property details from the property owner 140. The owner module 108 stores the data in the owners database 120. if it is determined that the owner did not approve of the notification or after the data is stored in the owners database 120 the owner module 108 returns to the net lease module 104.

Further, embodiments may include an investor module 110, which begins by being initiated by the net lease module 104. The investor module 110 connects to the investors 142. The investor module 110 identifies potential investors for an investment into the single reserve database 134. The investor module 110 sends a notification to the investors 142. The investor module 110 receives the investment from the investors 142. The investor module 110 stores the received investment from the investors 142 in the single reserve database 24. The investor module 110 returns to the net lease module 104.

Further, embodiments may include a manage module 112, which begins by being initiated by the net lease module 104. The manage module 112 extracts the first data entry in the lease database 118. The manage module 112 determines the fixed and variable costs for the property. The manage module 112 pays the costs of the property. The manage module 112 collects rent from the renters 146. The manage module 112 stores the rent in the single reserve database 134. The manage module 112 determines if there are more data entries remaining in the lease database 118. If it is determined that there are more data entries remaining in the lease database 118, the manage module 112 extracts the next data entry from the lease database 118. If it is determined that there are no more data entries remaining in the lease database 118, the manage module 112 returns to the net lease module 104.

Further, embodiments may include an accounting module 114, which begins by being initiated by the net lease module 104. The accounting module 114 determines the payment to the property owners 140. The accounting module 114 sends the payment to the property owners 140. The accounting module 114 determines the profits of the residential investments. The accounting module 114 sends the profits of the residential investments to the investors 142. The accounting module 114 returns to the net lease module 104.

| | Starting | Growth | | Vacancy | Rent | Home Price | Operating |
|---|---|---|---|---|---|---|---|
| Location | Market Rent | Rate | Inflation | Rate | Collectability | Appreciation | Expenses |
| Boston, MA | $4.60/sq. ft. | 5% | 7.70% | 0.47% | 99% | 8.11% | BostonOE.Data |
| New York, NY | $9.00/sq. ft. | 10% | 7.70% | 1.20% | 92% | 12% | NewYorkDE.Data |
| Los Angeles, CA | $7.00/sq. ft. | 8% | 7.70% | 3% | 91% | 10% | LosAngeles.Data |
| — | — | — | — | — | — | — | — |
| — | — | — | — | — | — | — | — |
| — | — | — | — | — | — | — | — |

### Example Expenses Database

Further, embodiments may include an expenses database 116, with an example expenses database shown above. The expenses database 116 contain may the location of where the market data is for, the starting market rent, the market growth rate, the inflation rate, the vacancy rate, the rent collectability rate, the home price appreciation, the operating expenses which are stored as a data file and may contain the local taxes, the insurance rates, the management amounts, the maintenance budget, the home owners association amounts, the cost of utilities, and the asset management amounts. In some embodiments, the market data may be for a specific location or region or may be specific to a certain property location. In some embodiments, each of the data points stored in the database may be used as an input into an algorithm to determine the net lease terms for the property owner 140, determine the rent for the specific property, and determine the profits or return on investment for the investors 142. In some embodiments, the starting market price may be the cost per square footage, the average cost of rent in a certain location, the average cost of rent in a certain location based on the number of bedrooms, the average cost of rent in a certain region of a city or town, etc. In some embodiments, the net lease module 104 may send a request to the expenses network 148 to receive data points that are relevant for a specific location of a property, for example, by using the mailing address.

| Property | | Lease | Lease | Lease Payment | Fixed | Rent | Monthly |
|---|---|---|---|---|---|---|---|
| Owner ID | Property ID | Length | Payment | Increase | Costs | Collected | Profits |
| IS123 | JS123-001 | 15 years | $2,000/month | 1% | $100/month | $2,500/month | $400 |
| JS123 | JS123-002 | 14 years | $2,200/month | 1% | $110/month | $2,700/month | $390 |
| JS123 | JS123-003 | 14 years | $1,800/month | 1.50% | $90/month | $2,300/month | $410 |
| — | — | — | — | — | — | — | — |
| TM456 | TM456-001 | 12 years | $3,000/month | 2% | $150/month | $3,700/month | $550 |
| TM456 | TM456-002 | 12 years | $2,500/month | 1.50% | $125/month | $3,200/month | $575 |
| TM456 | TM456-003 | 10 years | $2,800/month | 1.50% | $135/month | $3,400/month | $465 |
| — | — | — | — | — | — | — | — |
| HY789 | HY789-001 | 15 years | $2,300/month | 1% | $115/month | $2,900/month | $485 |
| HY789 | HY789-002 | 10 years | $2,200/month | 1% | $110/month | $2,800/month | $490 |
| HY789 | HY789-003 | 10 years | $2,500/month | 1.50% | $125/month | $3,100/month | $475 |
| — | — | — | — | — | — | — | — |
| — | — | — | — | — | — | — | — |
| — | — | — | — | — | — | — | — |

### Example Lease Database

Further, embodiments may include a lease database 118, with an example lease database shown above. The lease database 118 may contain a property owner ID, the property ID, the length of the lease or the years remaining on the net lease, the lease payment to the property owner 140, the annual increase of the net lease payment to the property owner, the fixed and variable costs per month for the property, the rent collected per month for the property, and the monthly profits for the property. In some embodiments, a property owner 140 may have multiple properties under a net lease with the net lease network 102. In some embodiments, the fixed and variable costs may differ for each property, or if there are multiple properties located within a certain radius, there may be vendor 144 and/or one property manager 136 for each of the properties to lower the monthly fixed and variable costs. In some embodiments, the database may be shown as monthly, quarterly, or annual payments, expenses, profits, etc. In some embodiments, the investors 142 may receive a percentage of the monthly profits or may be paid out based on quarterly or annual profits.

| Name | Owner ID | Property ID | Address | Square Footage | | Bedrooms | Bathrooms |
|---|---|---|---|---|---|---|---|
| John Smith | JS123 | JS123-001 | 123 main street, | 1,200 | sq. ft. | 2 | 1 |
| | | | Boston, MA | | | | |
| John Smith | JS123 | JS123-002 | 34 elm street, | 800 | sq. ft. | 1 | 1 |
| | | | Boston, MA | | | | |
| John Smith | JS123 | JS123-003 | 15 Maple Drive, | 1,500 | sq. ft. | 3 | 2 |
| | | | Boston, MA | | | | |

| | | | | | | |
|---|---|---|---|---|---|---|
| — | — | — | — | — | — | — |
| — | — | — | — | — | — | — |
| — | — | — | — | — | — | — |

### Example Owners Database

Further, embodiments may include an owners database 120, with an example owners database shown above. The owners database 120 may contain the list of the owners that are interested in receiving net lease terms from the net lease network 102. The database contains the owner's name, the owner ID, the property ID, the property address, the square footage, the number of bedrooms, and the number of bathrooms. In some embodiments, the owner may send the net lease network 102 more data on the location, such as average utility bills, property tax, insurance costs, condition of the property, condition of current appliances, etc. In some embodiments, the owner may send the net lease network 102 the current rates they charge for rent, if the property is vacant or if it currently has renters, the application process the owner uses for renters, etc.

| | Square | | | | Fixed | Potential |
|---|---|---|---|---|---|---|
| Location | Footage Range | Bedrooms | Bathrooms | Rent Range | Cost Range | Profit Range |
| Boston, MA | 800-800 | Studio | 1 | $1.600-$2,000 | $80-$120 | $300-$500 |
| Boston, MA | 800-1,000 | 1 | 1 | $1,800-$2,200 | $100-$130 | $400-$600 |
| Boston, MA | 1,000-1,200 | 2 | 1 | $2,200-$2,700 | $110-$150 | $500-$600 |
| — | — | — | — | — | — | — |
| — | — | — | — | — | — | — |
| — | — | — | — | — | — | — |

### Example Parameters Database

Further, embodiments may include a parameters database 122, with an example parameters database shown above. The parameters database 122 may contain the parameters created during the method described in the reserve module 106 that are used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some embodiments, the database may contain a plurality of locations based on the region of the country, the state the property resides in, the city where the property is located, the town or section of a city the property is located, etc. In some embodiments, the parameters may be determined by the property's square footage, the number of bedrooms the property has, the rent that may be charged for the residential property, or a combination of the parameters.

Further, embodiments may include an enhancement module 124, which begins by being initiated by the net lease module 104. The enhancement module 124 receives the created net lease terms from the net lease module 104. The enhancement module 124 extracts the historical data from the expenses database 116. The enhancement module 124 performs a stress scenario on the single reserve database 134 and backstop database 138 for the created net lease terms. The enhancement module 124 determines if the single reserve database 134 has an adequate amount for the created net lease terms. If it is determined that the single reserve database 134 does not have an adequate amount for the created net lease terms, the enhancement module 124 adds an amount to the single reserve database 134. If it is determined that the single reserve database 134 does have an adequate amount or after an additional amount has been added to the single reserve database 134, the enhancement module 124 determines if the backstop database 138 has an adequate amount for the created net lease terms. If it is determined that the backstop database 138 does not have an adequate amount for the created net lease terms, the enhancement module 124 adds an amount to the backstop database 138. If it is determined that the backstop database 138 does have an adequate amount or after an additional amount has been added to the backstop database 138, the enhancement module 124 returns to the net lease module 104.

Further, embodiments may include a credit module 126, which begins by being initiated by the net lease module 104. The credit module 126 connects to the renters 146. The credit module 126 receives the rental application from the renters 146. The credit module 126 stores the renter 146 data in the renter database 132. The credit module 126 connects to the 3rd party credit bureau network 152. The credit module 126 sends the renter 146 data to the 3rd party credit bureau network 152. The credit module 126 receives the credit data from the 3rd party credit bureau network 152. The credit module 126 determines if the renter's 146 credit data is above a predetermined threshold. If it is determined that the renter's 146 credit data is above the predetermined threshold, the credit module 126 stores that the renter's 146 credit check is approved in the renter database 132. Then the credit module 126 initiates the background module 128. If it is determined that the renter's 146 credit data is not above the predetermined threshold, the credit module 126 stores that the renter's 146 credit check is not approved in the renter database 132. Then the credit module 126 returns to the net lease module 104.

Further, embodiments may include a background module 128 which begins by being initiated by the credit module 126. The background module 128 extracts the renter 146 data from the renter database 132. The background module 128 connects to the 3rd party criminal database network 154, the 3rd party employment verification network 156, and the 3rd party financial verification network 158. The background module 128 sends the renter 146 data to the 3rd party criminal database network 154, the 3rd party employment verification network 156, and the 3rd party financial verification network 158. Then the background module 128 receives the data about the renter 146 from the 3rd party criminal database network 154, the 3rd party employment verification network 156, and the 3rd party financial verification network 158. The background module 128 determines if the renter 146 has a criminal record. If it is determined that the renter 146 has a criminal record, the background module 128 notifies an administrator of the net lease network 102. If it is determined that the renter 146 does not have a criminal record or that the administrator of the net lease network 102 has already been notified, the background module 128 stores the data in the renter database 132. The background module 128 determines if the renter's 146 employment is verified. If it is determined that the renter's 146 employment is not verified, the background module 128 notifies an administrator of the net lease network 102. If it is determined that the renter 146 employment is verified or that the administrator of the net lease network 102 has already been notified, the background module 128 stores the data in the renter database 132.

Then the background module 128 determines if the renter's 146 financials are verified. If it is determined that the renter's 146 financials are not verified, the background module 128 notifies an administrator of the net lease network 102. If it is determined that the renter's 146 financials are verified or that the administrator of the net lease network 102 has already been notified, the background module 128 stores the data in the renter database 132. Then the background module 128 initiates the market module 130.

Further, embodiments may include a market module 130, which begins by being initiated by the background module 128. In some embodiments, the market module 130 may be initiated periodically, such as weekly, monthly, quarterly, yearly, etc., to determine the status of the renter's 146 financial stability to pay the rent. The market module 130 extracts the first renter 146 from the renter database 132. The market module 130 connects to the 3rd party labor statistics network 160. The market module 130 receives the labor statistic data from the 3rd party labor statistics network 160. The market module 130 compares the extracted renter 146 data from the renter database 132 to the received labor statistics data from the 3rd party labor statistics network 160. The market module 130 determines if the renter 146 is currently in good standing. If it is determined that the renter 146 is not in good standing, the market module 130 connects to the 3rd party loan services network 162.

The market module 130 sends the renter 146 data to the 3rd party loan services network 162. The market module 130 receives the estimated loan terms from the 3rd party loan services network 162 for the renter 146. The market module 130 sends the received loan terms from the 3rd party loan services network 162 to the renter 146. If it is determined that the renter 146 is in good standing, the market module 130 determines if there are more renters 146 remaining in the renter database 132. If it is determined that there are more renters 146 remaining in the renter database 132, the market module 130 extracts the next renter 146 from the renter database 132, and the method returns to connecting the 3rd party labor statistics network 160. If it is determined that there are no more renters 146 remaining in the renter database 132, the market module 130 returns to the net lease module 104.

| | | | | | | | Criminal | | | Current |
|---|---|---|---|---|---|---|---|---|---|---|
| Owner ID | Property ID | Renter Name | Renter ID | Job Title | Industry | Credit | History | Employment | Financial | Status |
| JS123 | JS123-001 | Tom Barry | TB789 | Project | Construction | Approved | Yes | Verified | Not | Applicant |
| | | | | Manager | | | | | Verified | |
| JS123 | JS123-002 | Rick Martinez | RM132 | Surgeon | Healthcare | Not | — | — | — | Applicant |
| | | | | | | Approved | | | | |
| IS123 | JS123-003 | Sam Riley | SR456 | Teacher | Education | Approved | No | Verified | Verified | Good |
| | | | | | | | | | | Standing |
| — | — | — | — | — | — | — | — | — | — | — |
| TM456 | TM456-001 | Betty Clarke | BC852 | Nurse | Healthcare | Approved | No | Verified | Verified | Good |
| | | | | | | | | | | Standing |
| TM456 | TM456-002 | Susan Winter | SW741 | Accountant | Finance | Approved | No | Verified | Verified | Good |
| | | | | | | | | | | Standing |
| TM456 | TM456-003 | Mark Hodge | MH963 | Sales | Information | Approved | No | Verified | Verified | Loan |
| | | | | | Technology | | | | | Payments |
| — | — | — | — | — | — | — | — | — | — | — |
| HY789 | HY789-001 | Frank Wright | FW159 | Professor | Education | Approved | No | Verified | Verified | Loan |
| | | | | | | | | | | Payments |
| HY789 | HY789-002 | Grant Johnson | GJ357 | Manager | Retail | Approved | No | Verified | Verified | Good |
| | | | | | | | | | | Standing |
| HY789 | HY789-003 | Tina Summers | TS173 | Researcher | Pharma- | Approved | No | Verified | Verified | Good |
| | | | | | ceutical | | | | | Standing |
| — | — | — | — | — | — | — | — | — | — | — |
| — | — | — | — | — | — | — | — | — | — | — |
| — | — | — | — | — | — | — | — | — | — | — |

### Example Renters Database

Further, embodiments may include a renter database 132, with an example renter database shown above. The renter database 132 may contain the renter 146 data from either the property owner's 140 or the net lease network 102 receiving the data from the renters 146 applying for the rental property. The database is used by the credit module 126, background module 128, and market module 130 to determine the renter's 146 credit, criminal history, employment verification, financial verification, and to determine if the renter 146 is facing or will be faced with financial instability and to provide the renter 146 with an optional load to assist in making rental payments. The database contains the property owner's 140 ID, the property ID, the renter's 146 names, the renter's 146 ID, and information about the renter 146 such as job title, what industry they work in, their credit check, their criminal history, their employment verification, financial verification, and current status. In some embodiments, the database may contain the renter's 146 salaries along with their job title. In some embodiments, the database may contain the renter's 146 credit score.

In some embodiments, the database may contain the renter's 146 criminal offenses or list of criminal history, if any. In some embodiments, the database may contain the means to verify the renter's 146 employment, such as a pay stub, direct contact with the employer, etc. In some embodiments, the renter's 146 financial verification may include the renter's 146 tax information, such as salary, investments, supplemental income, savings in bank accounts, amount of debt, etc. In some embodiments, the renter's 146 status may be if they are applying to rent a property, currently are renting a property, if the renter is in good standing, such as they are up to date on payments, are not in danger of becoming unemployed, if they are in danger of facing financial instability due to employment issues or industry layoffs, if they are currently paying their rental payments with the assistance of a loan, etc.

Further, embodiments may include a single reserve database 134 in which the investors 142 investment is held in reserve in the event that the net lease networks 102 expenses are greater than the returns, or profits from the residential rental properties, to ensure payment to the property owners 140 according to the terms of their net lease. The single reserve database 134 may also be used to expand a line of credit for the net lease network 102 to add more residential rental properties to the lease database 118 by attracting more property owners 140. The single reserve database 134 may be accounted entirely through the upfront amounts paid by property owners 140. The calculation of the upfront amount paid by the property owner 140 may be based on an underwriting algorithm that identifies the relative risk of each property owner 140 and the market. In some embodiments, the single reserve database 134 may be stored and managed by a third party, such as a bank or financial institution. In some embodiments, the single reserve database 134 may be used for unexpected costs such as unexpected vacancy of the residential rental property, capital expenditures, variable costs, etc.

Further, embodiments may include a plurality of property managers 136, which may be a person or firm charged with operating a real estate property for a amount when the owner is unable to attend to such details personally or is not interested in doing so. For example, the property manager 136 may be required to find/evict tenants, deal with tenants, and coordinate with the net lease network 102. In addition, such arrangements may require the property manager 136 to collect rent and pay necessary expenses and taxes, making periodic reports to the owner, or the net lease network 102 may delegate specific tasks and deal with others directly. A property manager 136 may arrange for a wide variety of services, as may be requested by the net lease network 102, for a fec. Where a dwelling (vacation home, second home) is only periodically occupied, the property manager 136 might arrange for heightened security monitoring, house-sitting, storage and shipping of goods, and other local sub-contracting necessary to make the property comfortable for when a new tenant rents the property.

Further, embodiments may include a backstop database 138 in which the investors 142 investment may be stored and creates a secondary source of credit support in case the single reserve database 134 is insufficient to meet current needs. The net lease network 102 may allocate which investments from investors 142 are stored in the backstop database 138. The backstop database 138 may also be used to expand a line of credit for the net lease network 102 to add more residential rental properties to the lease database 118 by attracting more property owners 140. In some embodiments, the backstop database 138 may be stored and managed by a third party, such as a bank or financial institution. In some embodiments, the backstop database 138 may be used for unexpected costs such as unexpected vacancy of the residential rental property, capital expenditures, variable costs, etc.

Further, embodiments may include a plurality of property owners 140, which may be residential property owners that engage in a long-term net lease with the net lease network 102 to eliminate variability that comes with renting residential properties and decrease the time spent on making the residential rental property profitable. The long-term net lease with the net lease network 102 allows the property owner 140 to remove themselves from the responsibility of managing the property, paying taxes on the property, paying insurance on the property, maintaining the property, paying for utilities, paying for capital expenditures of the property, etc. and moving the responsibility to the net lease network 102 in exchange for net lease payment allowing the net lease network 102 controlling rights of the property.

Further, embodiments may include a plurality of investors 142, which provide an investment to the net lease network 102 to find residential properties to engage in long-term net leases in exchange for a percentage of the profits made on the residential properties as the return on the investment.

Further, embodiments may include a plurality of vendors 144, which may be the source of where the property managers 136 are assigned to the various residential rental properties and take care of the management of the property, management of the leases for the tenants, manage the maintenance of the property, track and collect rent from the tenants, track and maintain the relationship with the tenants, and manage the vacancy of the residential property.

Further, embodiments may include a plurality of property renters 146, which sign a rental agreement with the net lease network 102 to rent the residential property. The renters 146 may pay a monthly rental amount to live in the property, and the agreement may cover certain costs, such as heat, water, electricity, internet, etc. In some embodiments, the net lease network 102 may use a plurality of vendors 144 to assign property managers 136 to the residential rental property to take care and maintain the property on behalf of the net lease network 102 while collecting rent amounts, paying fixed and variable costs, and maintain the relationship with the renters 146.

Further, embodiments may include an expenses network 148, which includes a plurality of market data for the properties engaged or about to be engaged in a long-term net lease with the net lease network 102. The expenses network 148 may contain data for specific locations, cities, regions, or states to allow the most up-to-date market data for the net lease network 102 to use to create the net lease terms. The expenses network 148 may contain, for each specific location, the starting market rent, the market growth rate, the inflation rate, the vacancy rate, the rent collectability rate, the home price appreciation, and the operating expenses, which are stored as a data file and may contain the local taxes, the insurance rates, the management amounts, the maintenance budget, the homeowner's association amounts, the cost of utilities, and the asset management amounts. In some embodiments, the expenses network 148 may be connected to a plurality of third-party networks to compile the market data. In some embodiments, the expenses network 148 may continuously update the market data or may collect the specific market data based on a request from the net lease network 102. In some embodiments, the expenses network 148 may store the market data in a plurality of databases to extract and send the data as it is requested from the net lease network 102.

Further, embodiments may include a cloud 150, which is a distributed network of computers comprising servers and databases. A cloud 150 may be a private cloud 150, where access is restricted by isolating the network, preventing external access, or using encryption to limit access to only authorized users. Alternatively, a cloud 150 may be a public cloud 150 where access is widely available via the internet. A public cloud 150 may not be secured or may include limited security features.

Further, embodiments may include a 3rd party credit bureau network 152, which may include a network that collects information relating to the credit ratings of individuals and makes it available to credit card companies, financial institutions, etc. The credit ratings or credit score may be based on an individual's credit history, such as the number of open accounts, total levels of debt, repayment history, other factors, etc., and may be used by the net lease network 102 to evaluate the probability that an individual, such as a renter 146, will make rental payments in a timely manner.

Further, embodiments may include a 3rd party criminal database network 154, which may be a network connected to various criminal databases to determine an individual's criminal history. For example, the 3rd party criminal database network 154 may collect data about individuals from a national criminal records database, a statewide criminal record database, a county criminal record database, an FBI database, a sex offender registry, terrorist watch lists, etc.

Further, embodiments may include a 3rd party employment verification network 156, which may be a network for professional background screening firms and/or an employment verification service such as The Work Number® from Equifax. In some embodiments, the 3rd party employment verification network 156 may be a 3rd party service that reaches directly out to the renter's 146 or potential renter's 146 employers to confirm their employment history.

Further, embodiments may include a 3rd party financial verification network 158, which may be a network containing screening services to verify potential tenants' or renters' 146 financial records or income. In some embodiments, the income documents used to verify financial records or income may be pay stubs, tax returns, bank statements, employment letters, offer letters, etc. In some embodiments, the documents may include a list of investments or the renters' 146 investment portfolios.

Further, embodiments may include a 3rd party labor statistics network 160, which may be a network that measures labor market activity, working conditions, price changes, and productivity in the economy, such as the U.S. Bureau of Labor Statistics.

Further, embodiments may include a 3rd party loan service 3rd party loan services network 162, which may be a 3rd party that provides loans to renters 146 in a period of financial instability to ensure their rental payments. The 3rd party loan service network 162 may be a company that collects interest, principal, and escrow payments from a borrower.

FIG. 2 illustrates an example method performed by a net lease module.

The method begins with the net lease module 104 connecting to the expenses network 148 at step 200. For example, the net lease module 104 connects to the expenses network 148 through the cloud 150. In some embodiments, the connection may include a request from the net lease module 104 to receive the market data stored in the expenses network 148. In some embodiments, if the expenses network 148 connects to a plurality of third-party networks for the market data, the net lease module 104 may connect to each of the third-party networks to request the market data individually. In some embodiments, the request from the net lease module 104 may include a specific location, city, region, state, etc., for the desired market data.

At step 202, the net lease module 104 receives the data from the expenses network 148. For example, the net lease module 104 receives the market data from the expenses network 148, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

At step 204, the net lease module 104 stores the data from the expenses network 148 in the expenses database 116. For example, the net lease module 104 stores the market data in the expenses database 116, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

At step 206, the net lease module 104 initiates the reserve module 106. For example, the reserve module 106 begins by being initiated by the net lease module 104. The reserve module 106 extracts the first region from the expenses database 116. The reserve module 106 creates the region's net lease parameters. The reserve module 106 stores the parameters in the parameters database 122. The reserve module 106 determines if there are any more regions remaining in the expenses database 116. If it is determined that more regions remain in the expenses database 116, the reserve module 106 extracts the next region from the expenses database 116, and the method returns to creating the parameters for the net lease for the region. If it is determined that there are no more regions remaining in the expenses database 116, the reserve module 106 returns to the net lease module 104.

At step 208, the net lease module 104 initiates the owner module 108. For example, the owner module 108 begins by being initiated by the net lease module 104. The owner module 108 connects to the property owners 140. The owner module 108 identifies the potential property owners that may have a property that is within the parameters for a net lease. The owner module 108 sends a notification to the property owners 140 with a property that fulfills the parameters for a net lease. The owner module 108 determines if the owner approved the notification. If the owner approves the notification, the owner module 108 receives the property details from the property owner 140. The owner module 108 stores the data in the owners database 120. if it is determined that the owner did not approve of the notification or after the data is stored in the owners database 120, the owner module 108 returns to the net lease module 104.

At step 210, the net lease module 104 initiates the investor module 110. For example, the investor module 110 begins by being initiated by the net lease module 104. The investor module 110 connects to the investors 142. The investor module 110 identifies potential investors for investment into the single reserve database 134. The investor module 110 sends a notification to the investors 142. The investor module 110 receives the investment from the investors 142. The investor module 110 stores the received investment from the investors 142 in the single reserve database 24. The investor module 110 returns to the net lease module 104.

At step 212, the net lease module 104 extracts the first owner from the owners database 120. For example, the net lease module 104 extracts the data entry for the first owner and the first property for the owner, such as the property's location, the square footage, the number of bedrooms, and the number of bathrooms. In some embodiments, the data may include the average cost of utilities, property tax, insurance costs, condition of the property, condition of current appliances, the current rates they charge for rent, if the property is vacant or if it currently has renters, the application process the owner uses for renters, etc.

At step 214, the net lease module 104 connects to the vendors 144. For example, the net lease module 104 connects to the vendors 144 through the cloud 150 to find the average fixed and variable costs for the vendors in the region, city, state, etc., the property is located. In some embodiments, the net lease module 104 may have a plurality of agreements with a plurality of vendors 144 in a plurality of locations to assign property managers to maintain the residential properties.

At step 216, the net lease module 104 determines the fixed and variable costs for the property. For example, the net lease module 104 may determine the fixed and variable costs for each of the properties, such as by invoices inputted by vendors 144 or by the property managers 136, extracting the operating expenses from the expenses database 116, etc.

At step 218, the net lease module 104 creates the net lease terms for the property owner. For example, the net lease module 104 may determine the residential property's location and then use the data stored in the expenses database 116 as inputs into an algorithm that outputs the net lease payment terms for the property owner 140. For example, if the residential rental property is located in Boston, MA, then the starting market rent, the market growth rate, the inflation rate, the vacancy rate, the rent collectability rate, the home price appreciation, the operating expenses such as the local taxes, the insurance rates, the management fees, the maintenance budget, the home owners association fees, the cost of utilities, and the asset management fees would be used as inputs into the algorithm to determine the net lease payment.

For example, the algorithm may use the average rent per square footage, and the square footage of the property owners 140 residential property to determine the cost of rent for the property, such the average rent per square foot is $4.50 in Boston, MA, and the property owners 140 property is 800 square feet, resulting in a rent price of $3,600 per month. The other inputs, such as the market growth rate, the inflation rate, the vacancy rate, the rent collectability rate, the home price appreciation, the operating expenses, etc., may be used in the algorithm as weighted averages or percentages to increase or decrease the rental price of the property.

The algorithm may offer the property owner 140 net lease terms based on a percentage of the possible rent that the net lease network 102 could charge tenants, such as 75% or $2,700 per month, over the length of 15 years, allowing the property owner 140 to be free of the responsibilities associated with renting a property and providing them with a steady payment for the residential rental property. In some embodiments, the property owner 140 may be offered an annual increase percentage of the net lease payment due to inflation, market growth rate, etc. In some embodiments, the net lease module 104 may send the created net lease terms to the enhancement module 124 to determine if the single reserve database 134 and the backstop database 138 have an adequate amount for the created net lease terms.

At step 220, the net lease module 104 initiates the enhancement module 124. For example, the enhancement module 124 begins by being initiated by the net lease module 104. The enhancement module 124 receives the created net lease terms from the net lease module 104. The enhancement module 124 extracts the historical data from the expenses database 116. The enhancement module 124 performs a stress scenario on the single reserve database 134 and backstop database 138 for the created net lease terms. The enhancement module 124 determines if the single reserve database 134 has an adequate amount for the created net lease terms. If it is determined that the single reserve database 134 does not have an adequate amount for the created net lease terms, the enhancement module 124 adds an adequate amount to the single reserve database 134. If it is determined that the single reserve database 134 does have an adequate amount or after an additional amount has been added to the single reserve database 134, the enhancement module 124 determines if the backstop database 138 has an adequate amount for the created net lease terms. If it is determined that the backstop database 138 does not have an adequate amount for the created net lease terms, the enhancement module 124 adds an adequate amount to the backstop database 138. If it is determined that the backstop database 138 does have an adequate amount or after an additional amount has been added to the backstop database 138, the enhancement module 124 returns to the net lease module 104.

In some cases, the enhancement module 124 may generate one or more stress scenarios based on the net lease terms, extracted historical trend data that impact the fixed costs and variable costs from an expenses database 116, and an accounting at the single reserve database 134. The one or more stress scenarios may select a multiplier and a predicted amount for future expenses based on the historical data in varied scenarios. The enhancement module 124 may determine that the backstop database 138 to the single reserve database 134 does not have a sufficient backstop amount to cover the multiplier of the predicted amount based on results of the stress scenario. In some cases, based upon the determination and over the communication network, an instruction to trigger a transfer of a difference between the sufficient backstop amount and an accounting at the backstop database to the backstop database 138 may be sent.

In some cases, a machine-learning model may be used to initialize the one or more stress scenarios. The machine-learning model may select the predicted amount between an upper bound and a lower bound and a multiplier between a multiplier upper bound and a multiplier lower bound based on weights set by training data including the extracted historical data. The machine-learning model may retrain new extracted historical data. For example, when time passes, new data about a more current economic landscape may be available. The machine-learning model may be retrained to initialize one or more new stress scenarios. The machine-learning model may select a new predicted amount between a new upper bound and a new lower bound and a new multiplier between a new multiplier upper bound and a new multiplier lower bound based on new weights set by new training data including the new extracted historical data.

The enhancement module may determine that the backstop database to the single reserve database does not have a sufficient backstop amount to cover the multiplier of the predicted amount based on results of the stress scenario. Based upon the determination and over the communication network, an instruction to trigger a transfer of a difference between the sufficient backstop amount and an accounting at the backstop database to the backstop database may be sent.

At step 222, the net lease module 104 determines if the property owner 140 approved the net lease terms. For example, the property owner 140 may send the signed agreements back to the net lease module 104 or net lease network 102 to approve the net lease terms. In some embodiments, the property owner 140 may have a login, such as a username and password, account, access to the net lease network 102, etc., to approve the net lease terms. In some embodiments, an administrator of the net lease network 102 may collect the signed agreements from the property owners 140 and store the data in the net lease network 102 to approve the net lease terms.

If it is determined that the property owner 140 approved the net lease terms, the net lease module 104 assigns a property manager 136 to the property at step 224. For example, the net lease module 104 may assign a property manager 136 to the residential property. In some embodiments, the property manager 136 may be assigned by one of the vendors 144 with the net lease network 102 has an agreement with. In some embodiments, the property manager 136 may be a person or firm charged with operating a real estate property for a fee when the owner is unable to attend to such details personally or is not interested in doing so. For example, the property manager 136 may be required to find/evict tenants, deal with tenants, and coordinate with the net lease network 102. In addition, such arrangements may require the property manager 136 to collect rents and pay necessary expenses and taxes, making periodic reports to the owner, or the net lease network 102 may delegate specific tasks and deal with others directly.

At step 226, the net lease module 104 stores the data in the lease database 118. For example, the net lease module 104 stores the data created from the net lease terms in the lease database 118, such as a property owner ID, the property ID, the length of the lease or the years remaining on the net lease, the lease payment to the property owner 140, the annual increase of the net lease payment to the property owner, the fixed and variable costs per month for the property, the rent collected per month for the property, etc.

At step 228, the net lease module 104 determines if the property owners 140 needs a renter 146. For example, the property owner 140 may send the net lease module 104 the current status of the renters 146 for each of their properties and the renter 146 data, or if the property is currently vacant and that the property requires a renter 146.

If it is determined that the property does need a renter 146, the net lease module 104 initiates the credit module 126 at step 230. For example, the credit module 126 begins by being initiated by the net lease module 104. The credit module 126 connects to the renters 146. The credit module 126 receives the rental application from the renters 146. The credit module 126 stores the renter 146 data in the renter database 132. The credit module 126 connects to the 3rd party credit bureau network 152. The credit module 126 sends the renter 146 data to the 3rd party credit bureau network 152. The credit module 126 receives the credit data from the 3rd party credit bureau network 152. The credit module 126 determines if the renter's 146 credit data is above a predetermined threshold. If it is determined that the renter's 146 credit data is above the predetermined threshold, the credit module 126 stores that the renter's 146 credit check is approved in the renter database 132. Then the credit module 126 initiates the background module 128. If it is determined that the renter's 146 credit data is not above the predetermined threshold, the credit module 126 stores that the renter's 146 credit check is not approved in the renter database 132. Then the credit module 126 returns to the net lease module 104.

If it is determined that the property does not need a renter 146, the net lease module 104 stores the renter 146 data in the renter database 132 at step 232. For example, the net lease module 104 may receive the renter 146 data from the property owner 140 and store the data in the renter database 132 such as the property owner 140 ID, the property ID, the renter's 146 names, the renter's 146 ID, and information about the renter 146 such as job title, what industry they work in, their credit check, their criminal history, their employment verification, financial verification, and current status. In some embodiments, the database may contain the renter's 146 salaries along with their job title. In some embodiments, the database may contain the renter's 146 credit score. In some embodiments, the database may contain the renter's 146 criminal offenses or list of criminal history, if any. In some embodiments, the database may contain the means to verify the renter's 146 employment, such as a pay stub, direct contact with the employer, etc. In some embodiments, the renter's 146 financial verification may include the renter's 146 tax information, such as salary, investments, supplemental income, savings in bank accounts, amount of debt, etc. In some embodiments, the renter's 146 status may be if they are applying to rent a property, currently are renting a property, if the renter is in good standing, such as they are up to date on payments, are not in danger of becoming unemployed, if they are in danger of facing financial instability due to employment issues or industry layoffs, if they are currently paying their rental payments with the assistance of a loan, etc.

If it is determined that the property owner 140 did not approve of the net lease terms or after the data is stored in the lease database 118, the net lease module 104 determines if there are any property owners 140 remaining in the owners database 120 at step 234. If it is determined that more owners are remaining in the owners database 120, the net lease module 104 extracts, at step 236, the next owner from the owners database 120, and the method returns to connecting to the vendors 144. If it is determined that there are no more owners remaining in the owners database 120, the net lease module 104 initiates, at step 238, the manage module 112. For example, the manage module 112 begins by being initiated by the net lease module 104. The manage module 112 extracts the first data entry in the lease database 118. The manage module 112 determines the fixed and variable costs for the property. The manage module 112 pays the costs of the property. The manage module 112 collects rent from the renters 146. The manage module 112 stores the rent in the single reserve database 134. The manage module 112 determines if there are more data entries remaining in the lease database 118. If it is determined that there are more data entries remaining in the lease database 118, the manage module 112 extracts the next data entry from the lease database 118. If it is determined that there are no more data entries remaining in the lease database 118, the manage module 112 returns to the net lease module 104.

Then the net lease module 104 initiates, at step 240, the accounting module 114, and the method returns to connecting to the expenses network 148. For example, the accounting module 114 begins by being initiated by the net lease module 104. The accounting module 114 determines the payment to the property owners 140. The accounting module 114 sends the payment to the property owners 140. The accounting module 114 determines the profits of the residential investments. The accounting module 114 sends the profits of the residential investments to the investors 142. The accounting module 114 returns to the net lease module 104.

FIG. 3 illustrates an example method performed by a reserve module in accordance with some aspects of the present technology.

FIG. 3 displays the manage module 112. The method begins with the manage module 112 being initiated, at step 300, by the reserve module 106. In some aspects, the manage module 112 may not need to be initiated and is continuously running in the background of the net lease network 102.

The manage module 112 extracts, at step 302, the first region from the investor module 110. For example, the manage module 112 extracts the first region from the investor module 110, such as the state, city, town, etc., that the expenses data and market data are related to.

The manage module 112 creates, at step 304, the parameters for the net lease for the region. For example, the manage module 112 may use the data stored in the expenses database to create parameters for residential net leases to identify residential properties that would be profitable with a residential net lease. For example, if the manage module 112 may calculate an average range that could be charged for rent depending on the cost per square foot, such as if renters in Boston, MA, typically pay $4.50 per square foot of a property and the average square footage of a studio apartment is 800 square feet to 1,000 square feet, the average rent for a studio apartment may be $3,600 to $4,500.

In some aspects, the calculations may incorporate the number of bedrooms and bathrooms to adjust the average rental price based on square footage. In some aspects, the calculations may incorporate the area's average fixed and variable costs of properties. In some aspects, the calculations may use the average rental price and average fixed and variable costs to determine the average profit of a rental property. In some aspects, the calculations may use a percentage of the average rental price to determine the average payment to a property owner 140 to determine the profits, for example, if the average rent price was $3,600 a month. The owner 140 typically received a payment of 80% for a net lease agreement, then the calculations would subtract the 80% for the net lease and the fixed and variable costs to determine the average monthly profit of a residential rental property.

The manage module 112 stores, at step 306, the parameters in the renter database 132. For example, the manage module 112 may store all the data from the calculating the parameters in the renter database 132, such as the location or region, the square foot range of the property, the number of bedrooms, the number of bathrooms, the rent range that could be charged for the property, the average range of fixed and variable costs for the property, and the potential profit range of the property.

The manage module 112 determines, at step 308, if there are any more regions remaining in the investor module 110. For example, if there are more regions, cities, towns, etc., in the investor module 110, the manage module 112 extracts the next region, and the method returns to determine the region's parameters.

If it is determined that more regions remain in the investor module 110, the manage module 112 extracts, at step 310, the next region from the investor module 110, and the method returns to creating the parameters for the net lease for the region. If it is determined that there are no more regions remaining in the investor module 110, the manage module 112 returns, at step 312, to the reserve module 106.

FIG. 4 illustrates an example method performed by an owner module in accordance with some aspects of the present technology.

FIG. 4 displays the accounting module 114. The method begins with the accounting module 114 being initiated, at step 400, by the reserve module 106. In some aspects, the accounting module 114 may not need to be initiated and is continuously running in the background of the net lease network 102.

The accounting module 114 connects, at step 402, to the parameters databases 122. For example, the accounting module 114 connects to the parameters databases 122 through the expenses network 148, owners 140 may log in to the net lease network 102, sign up to the net lease network 102, etc. In some aspects, the accounting module 114 may find potential parameters databases 122 through rental listings, apartment listings, etc., and offer the property owner 140 the net lease terms once they are created. In some aspects, the property owner 140 may be required to input their information, such as name, location of the residential rental property, e-mail address, etc., to receive the net lease terms from the accounting module 114.

The accounting module 114 identifies, at step 404, the potential property owners that may have a property that is within the parameters for a net lease. For example, the accounting module 114 may identify residential properties that would be candidates for residential net leases by comparing the readily available data on the properties to the parameters stored in the parameters database 122. For example, the owner 140 may send data to the accounting module 114, such as square footage, number of bedrooms, number of bathrooms, current rent, etc., and the accounting module 114 compares the received data to the renter database 132 to determine if the received data falls within the parameters. In some aspects, the accounting module 114 may use third-party sources to extract the data on the residential properties to determine if the property falls within the range of the parameters stored in the parameters database 122.

The accounting module 114 sends, at step 406, a notification to the parameters databases 122 that have a property that fulfills the parameters for a net lease. For example, if the residential property data is within the parameters of the parameters database 122, then the accounting module 114 may send a notification, such as an e-mail, automated phone call, notification through the net lease network 102, etc., to the owner. In some aspects, the accounting module 114 may send the owner an estimate of a potential net lease agreement.

The accounting module 114 determines, at step 408, if the owner approves the notification. For example, the accounting module 114 determines if the owner 140 responds to the notification by e-mail, logging onto the net lease network 102, etc. If the owner approves the notification, the accounting module 114 receives, at step 410, the property details from the property owner 140. For example, the owner 140 sends the owner module the data related to the residential property, such as the square footage, number of bedrooms, number of bathrooms, current condition of the property, the current condition of the appliances, current rent, the current property management group, etc.

The accounting module 114 stores, at step 412, the data in the owners database 120. For example, the accounting module 114 stores the received data in the owners database 120, such as the owner's name, the owner ID, the property ID, the property address, the square footage, the number of bedrooms, and the number of bathrooms, average utility bills, property tax, insurance costs, condition of the property, condition of current appliances, current rates they charge for rent, if the property is vacant or if it currently has renters, the application process the owner uses for renters, etc. if it is determined that the owner did not approve of the notification or after the data is stored in the owners database 120 the accounting module 114 returns, at step 414, to the reserve module 106.

FIG. 5 illustrates an example method performed by an investor module in accordance with some aspects of the present technology.

The method begins with the investor module 110 being initiated, at step 500, by the net lease module 104. In some embodiments, the investor module 110 may not need to be initiated and is continuously running in the background of the net lease network 102.

The investor module 110 connects, at step 502, to the investors 142. For example, the investor module 110 may connect to the investors 142 through the cloud 150, investors may log in to the net lease network 102, sign up to the net lease network 102, etc. In some embodiments, the investor module 110 may provide the investors 142 with certain documents such as income statements, balance sheets, capital requirements, investor agreements, term sheets, business plans, etc.

The investor module 110 identifies, at step 504, potential investors for an investment into the reserve database 134. For example, the investor module 110 may identify potential investors for an investment by collecting e-mails of investors that visit the net lease network 102, sign up for the net lease network 102 by creating a username and password, etc.

The investor module 110 sends, at step 506, a notification to the investors 142. For example, the investor module 110 may send an e-mail notification, notification through the net lease network 102, etc., to notify the investors. In some embodiments, the investor module 110 may provide the investors 142 with certain documents such as income statements, balance sheets, capital requirements, investor agreements, term sheets, business plans, etc.

The investor module 110 receives, at step 508, the investment from the investors 142. For example, the investor module 110 receives an investment from the investor 142, which may include a certain amount of capital to invest in the net lease agreements for residential rental properties. In some embodiments, the investor module 110 may send the investor 142 the investment agreement, contract, etc.

The investor module 110 stores, at step 510, the received investment from the investors 142 in the reserve database 24. For example, the investor module 110 stores the received investment in the reserve database 134 in which the investors 142 investment is stored as capital in the event that the net lease networks 102 expenses are greater than the returns, or profits from the residential rental properties, to ensure payment to the property owners 140 according to the terms of their net lease. The reserve database 134 may also be used to expand a line of credit for the net lease network 102 to add more residential rental properties to the lease database 118 by attracting more property owners 140. In some embodiments, the reserve database 134 may be stored and managed by a third party, such as a bank or financial institution. In some embodiments, the reserve database 134 may be used for unexpected costs such as unexpected vacancy of the residential rental property, capital expenditures, variable costs, etc. The investor module 110 returns, at step 512, to the net lease module 104.

FIG. 6 illustrates an example method performed by a manage module.

The method begins with the manage module 112 being initiated, at step 600, by the net lease module 104. In some embodiments, the manage module 112 may not need to be initiated and is continuously running in the background of the net lease network 102.

The manage module 112 extracts, at step 602, the first data entry in the lease database 118. For example, the manage module extracts the first data entry in the lease database 118, such as the first property. The manage module 112 determines, at step 604, the fixed and variable costs for the property. For example, the manage module 112 may determine the fixed and variable costs for each of the properties, such as by invoices inputted by vendors 144 or by the property managers 136, extracting the operating expenses from the expenses database 116, etc. In some embodiments, the property manager 136 may be responsible for sending invoices of the fixed and variable costs for each property, and the manage module 112 may extract the funds from the reserve database 134 to pay for the invoices.

The manage module 112 pays, at step 606, the costs of the property. For example, the manage module 112 may pay for the costs of the property by sending the payment from the reserve database 134 to the vendors 144 or property manager 136. In some embodiments, the vendors 144 or property manager 136 may submit invoices to be paid through the net lease network 102, and the manage module 112 extracts the payment from the reserve database 134 and sends the payment to the vendors 144 or property manager 136.

The manage module 112 collects, at step 608, rent from the renters 146. For example, the manage module 112 may collect the rent from the residential rental properties by sending a notification to the property manager 136 or receiving a notification from the property manager 136 to determine if the rent for the rental property has been collected for the month. In some embodiments, the property manager 136 may use the manage module 112 or net lease network 102 to collect rent from the tenants, such as by the tenant's sign into the net lease network 102 and sending the payment electronically.

The manage module 112 stores, at step 610, the rent in the reserve database 134. For example, the manage module 112 stores that the rent has been collected and stores the amount collected for each rental property in the reserve database 134. In some embodiments, the rent may be stored in the reserve database 134 to be used to pay for the fixed and variable costs of the rental property. In some embodiments, the reserve database 134 may be used to pay for fixed or variable costs for other rental properties being managed by the net lease network 102. In some embodiments, the rent payment may be stored in the reserve database 134 by connecting the renter 146 to the net lease network 102 and submitting the payment which is automatically transferred to the financial account of the reserve database 134.

The manage module 112 determines, at step 612, if there are more data entries remaining in the lease database 118. For example, the manage module 112 extracts the next data entry to pay the costs of the next property and collect the rent of the next property until all of the properties in the lease database 118 have paid the associated property costs and collected rent from all of the renters 146.

If it is determined that there are more data entries remaining in the lease database 118, the manage module 112 extracts, at step 614, the next data entry from the lease database 118. If it is determined that there are no more data entries remaining in the lease database 118, the manage module 112 returns, at step 616, to the net lease module 104.

FIG. 7 illustrates an example method performed by an accounting module in accordance with some aspects of the present technology.

The method begins with the accounting module 114 being initiated, at step 700, by the net lease module 104. In some embodiments, the accounting module 114 may not need to be initiated and is continuously running in the background of the net lease network 102.

The accounting module 114 determines, at step 702, the payment to the property owners 140. For example, the accounting module 114 may determine the payment to the property owner 140 by extracting the net lease payment from the lease database 118 and extracting the amount from the reserve database 134 to send to the property owner 140. In some embodiments, if a property owner 140 has multiple properties on the net lease network 102, the accounting module 114 may filter the lease database 118 on the property owner 140 ID and determine the sum of all the net lease payments owed to the property owner 140 and extract the funds from the reserve database 134 to send to the property owner 140. In some embodiments, if there is a plurality of property owners 140, the accounting module 114 may extract a first property owner 140 and determine the payment, send the payment, and then select the next property owner 140 until all the property owners 140 stored in the lease database 118 are paid. In some embodiments, the payments may be determined by the net lease terms and sent based on a specific schedule, and may be paid out monthly, quarterly, annually, etc.

The accounting module 114 sends, at step 704, the payment to the property owners 140. For example, the accounting module 114 may send the net lease payment to the property owner 140 by extracting the amount owed to the property owner 140 from the reserve database 134 and sending the payment electronically to the property owner 140.

The accounting module 114 determines, at step 706, the profits of the residential investments. For example, the accounting module 114 may determine the profits of the residential investments by extracting the payment to the property owners 140, the cost of the properties, and the rent collected on the property. Then the accounting module 114 may add the payment to the property owners and the cost of the property together and subtract the total from the rent collected to determine the monthly profit of the property. The accounting module 114 may add the sum of all the profits for the residential rental properties to determine the total profit. In some embodiments, the profits may be stored in the lease database 118. In some embodiments, the profits may be determined monthly, quarterly, annually, etc.

The accounting module 114 sends, at step 708, the profits of the residential investments to the investors 142. For example, the accounting module 114 may send the profits to investors 142 that had invested in the net lease network 102. For example, the investors 142 may have a certain percentage of profits they are entitled to based upon their investor agreement. For example, if an investor 142 agreed to invest $1,000 for 1% of the profits and the total monthly profits were $4,000, then the investor 142 would be entitled to $40 for the monthly profits. In some embodiments, the investor agreements may be stored in the net lease network 102. In some embodiments, the accounting module 114 may extract each investor 142 agreement and the percentages of the profits that they are owed and extract the amount from the reserve database 134 to pay the investors 142 their return on investment. In some embodiments, the investors 142 may be paid out monthly, quarterly, annually, etc.

The accounting module 114 returns, at step 710, to the net lease module 104.

FIG. 8 illustrates an example method performed by an enhancement module in accordance with some aspects of the present technology.

The enhancement module 124 may be initiated at step 800, by the reserve module 106. For example, the enhancement module 124 may be initiated once the net lease terms are created to determine if there is an adequate amount in the single reserve database 134 and the single reserve database 134. The single reserve database 134 and the single reserve database 134 may be required to hold an amount covering the payments and expenses for the residential net lease, including higher than expected fixed and/or variable expenses, a decrease in rentability, etc.

The enhancement module 124 receives, at step 802, the created net lease terms from the reserve module 106. For example, the enhancement module 124 may receive the property owner ID, the property ID, the length of the lease or the years remaining on the net lease, the lease payment to the property owner 140, the annual increase of the net lease payment to the property owner, the fixed and variable costs per month for the property, the rent collected per month for the property, etc.

The enhancement module 124 extracts, at step 804, the historical data from the investor module 110. For example, the enhancement module 124 extracts the historical data from the investor module 110, such as the starting market rent, the market growth rate, the inflation rate, the vacancy rate, the rent collectability rate, the home price appreciation, the operating expenses which are stored as a data file and may contain the local taxes, the insurance rates, the management amounts, the maintenance budget, the homeowner's association amounts, the cost of utilities, the asset management amounts, etc.

The enhancement module 124 performs, at step 806, a stress scenario on the single reserve database 134 and single reserve database 134 for the created net lease terms. For example, the enhancement module 124 may perform a stress scenario on the created net lease terms to determine if there is an adequate amount in the single reserve database 134 and the single reserve database 134, which may be required to hold an amount that will cover the payments and expenses for the residential net lease including in the event of higher than expected fixed and/or variable expenses, decrease in rentability, etc. that will of greatly increasing the credit quality of the tenant for the benefit of property owners in regards to the stability and quality of their net lease income. For example, the enhancement module 124 may determine the amount needed for the single reserve database 134 and the backstop database by determining how much should be in the accounting at the time of the residential net lease.

The enhancement module 124 may calculate the required amount need by using the initial lease payment received from the property manager 136 and adding the historically expected market rent increases or decreases and subtracting the total of the net lease payments to the owners 140 and property expenses multiplied by the length of the lease and then multiplying the result by a margin of error of 100% to ensure that there are enough amount stored in the single reserve database 134 for the first year of the residential net lease and enough amount stored in the single reserve database 134 for the length of the residential net lease for the additional years. For example, if the property generates $20,000 from the property manager 136 expected lease and the costs of paying the property owner 140 their net lease terms and the property expenses equals $10,000, that results in a profit of $10,000, which would be stored in the single reserve database. The profit is then multiplied by a margin of error of 100% to ensure the single reserve database can make payments and cover costs in the event of an unexpected scenario, such as a decrease in rent, market prices decrease for rent, unexpected 32 costs, etc. which would result in the single reserve database 134 to be required to store $20,000 for the residential net lease terms. The backstop database would be required to hold this amount for every year of the residential net lease plus an additional margin of error to cover costs in the event of an unexpected scenario, such as a decrease in rent, market prices decrease for rent, unexpected costs, etc. For example, if the single reserve database 134 is required to hold $20,000 and the residential net lease is for 10 years, the single reserve database 134 would be required to hold an amount for the additional nine years with a margin of error of 100%, which would require the single reserve database 134 to hold $600,000 for the remaining years of the residential net lease.

The enhancement module 124 determines, at step 808, if the single reserve database 134 has an adequate amount for the created net lease terms. For example, the enhancement module 124 would take the calculations previously described and determine if there are enough accounting to cover a stress scenario for the residential net lease. For example, if the single reserve database 134 is required to have $20,000 in accounting for the residential net lease and the single reserve database 134 only has $10,000, then the single reserve database 134 needs an additional amount for the residential net lease. However, if the single reserve database 134 is required to have $20,000 in accounting for the residential net lease and the single reserve database 134 has $30,000, then there are enough amount to cover a stress scenario for the residential net lease.

If it is determined that the single reserve database 134 does not have an adequate amount for the created net lease terms, the enhancement module 124 records, at step 810, an added amount to the single reserve database 134. For example, the amount may be added through the investors 142, such as by initiating the expenses database 116, in which case the expenses database 116 connects to the investors 142, identifies potential investors for investment into the single reserve database 134, sends a notification to the investors 142, receives the investment from the investors 142, and stores the received investment from the investors 142 in the single reserve database 134.

If it is determined that the single reserve database 134 does have an adequate amount or after an additional amount has been added to the single reserve database 134, the enhancement module 124 determines, at step 812, if the single reserve database 134 has an adequate amount for the created net lease terms. For example, the enhancement module 124 would take the calculations previously described and determine if there are enough accounting to cover a stress scenario for the residential 33 net lease over the length of the lease terms. For example, if the single reserve database 134 is required to have $600,000 in accounting for the length of the residential net lease and the single reserve database 134 only has $500,000, then the single reserve database 134 needs an additional amount for the length of the residential net lease. However, if the single reserve database 134 is required to have $600,000 in accounting for the residential net lease and the single reserve database 134 has $700,000, then there are enough amount to cover a stress scenario for the residential net lease over the length of the lease.

If it is determined that the single reserve database 134 does not have an adequate amount for the created net lease terms, the enhancement module 124 records, at step 814, an added amount to the backstop database 138. For example, the amount may be added through the investors 142, such as by initiating the expenses database 116, in which case the expenses database 116 connects to the investors 142, identifies potential investors for investment into the single reserve database 134, sends a notification to the investors 142, receives the investment from the investors 142, and stores the received investment from the investors 142 in the backstop database 138.

If it is determined that the backstop database 138 does have an adequate amount or after an additional amount has been added to the backstop database 138, the enhancement module 124 returns, at step 816, to the reserve module 106.

FIG. 9 illustrates an example method performed by a credit module.

The example method begins with the credit module 126 being initiated, at step 900, by the net lease module 104. In some embodiments, the credit module 126 may be initiated once a renter 146 connects to the net lease network 102 and applies for a rental property. In some embodiments, the credit module 126 may be initiated based on a time period, such as weekly, monthly, quarterly, yearly, etc., to continuously check the credit scores of the current tenants by extracting each renter 146 from the renter database 132 and sending their data to the 3rd party credit bureau network 152.

The credit module 126 connects, at step 902, to the renters 146. For example, the credit module 126 may connect to renters 146 through the cloud 150. In some embodiments, renters 146 may have an account on the net lease network 102 to view rental properties and apply to rent the properties. The credit module 126 receives, at step 904, the rental application from the renters 146. For example, the credit module 126 may receive data about the renter 146 through the application, such as the property owner's 140 ID and the property ID of the desired rental property, the renter's 146 names, the renter's 146 ID, and information about the renter 146 such as job title, what industry they work in, their credit check, their criminal history, their employment verification, financial verification, and current status.

The credit module 126 stores, at step 906, the renter 146 data in the renter database 132. For example, the credit module 126 stores the renter 146 data in the renter database 132, such as the property owner's 140 ID and the property ID of the desired rental property, the renter's 146 names, the renter's 146 ID, and information about the renter 146 such as job title, what industry they work in, their credit check, their criminal history, their employment verification, financial verification, and current status.

The credit module 126 connects, at step 908, to the 3rd party credit bureau network 152. For example, the credit module 126 connects to the 3rd party credit bureau network 152 through the cloud 150. In some embodiments, the net lease network 102 may have a subscription to a 3rd party credit bureau to perform credit checks on current and potential renters 146. In some embodiments, the net lease network 102 may access a plurality of 3rd parties through an API connection.

The credit module 126 sends, at step 910, the renter 146 data to the 3rd party credit bureau network 152. For example, the credit module 126 sends the renter 146 data, such as their name, job title, industry, credit check, criminal history, employment verification, financial verification, and current status.

The credit module 126 receives, at step 912, the credit data from the 3rd party credit bureau network 152. For example, the credit module 126 may receive the renter's 124 credit score from the 3rd party credit bureau network 152.

The credit module 126 determines, at step 914, if the renter's 146 credit data is above a predetermined threshold. For example, the net lease network 102 may have a predetermined threshold for credit scores for potential renters 146, such as above 675, and if the renter's 146 credit score is below the predetermined amount, the renter 146 may not be approved to rent the property. If the renter's 146 credit score is above the predetermined threshold, the method continues to perform a background check on the potential renter 146 to determine if the renter 146 is a strong candidate for renting the property. In some embodiments, the predetermined threshold may be based on a national average, based on the location of the rental property, the type of rental property, the rental payments for the property, etc.

If it is determined that the renter's 146 credit data is above the predetermined threshold, the credit module 126 stores, at step 916, that the renter's 146 credit check is approved in the renter database 132. For example, the credit module 126 may store that the renter's 146 credit check is approved in the renter database 132. The credit module 126 may store the renter's 146 actual credit score in some embodiments.

Then the credit module 126 initiates, at step 918, the background module 128. For example, the background module 128 begins by being initiated by the credit module 126. The background module 128 extracts the renter 146 data from the renter database 132. The background module 128 connects to the 3rd party criminal database network 154, the 3rd party employment verification network 156, and the 3rd party financial verification network 158. The background module 128 sends the renter 146 data to the 3rd party criminal database network 154, the 3rd party employment verification network 156, and the 3rd party financial verification network 158. Then the background module 128 receives the data about the renter 146 from the 3rd party criminal database network 154, the 3rd party employment verification network 156, and the 3rd party financial verification network 158.

The background module 128 determines if the renter 146 has a criminal record. If it is determined that the renter 146 has a criminal record, the background module 128 notifies an administrator of the net lease network 102. If it is determined that the renter 146 does not have a criminal record or that the administrator of the net lease network 102 has already been notified, the background module 128 stores the data in the renter database 132. The background module 128 determines if the renter's 146 employment is verified. If it is determined that the renter's 146 employment is not verified, the background module 128 notifies an administrator of the net lease network 102. If it is determined that the renter 146 employment is verified or that the administrator of the net lease network 102 has already been notified, the background module 128 stores the data in the renter database 132. Then the background module 128 determines if the renter's 146 financials are verified. If it is determined that the renter's 146 financials are not verified, the background module 128 notifies an administrator of the net lease network 102. If it is determined that the renter's 146 financials are verified or that the administrator of the net lease network 102 has already been notified, the background module 128 stores the data in the renter database 132.

Then the background module 128 initiates the market module 130. If it is determined that the renter's 146 credit data is not above the predetermined threshold, the credit module 126 stores, at step 920, that the renter's 146 credit check is not approved in the renter database 132. In some embodiments, the credit module 126 may notify the renter 146 that they are not approved for the rental property. Then the credit module 126 returns, at step 922, to the net lease module 104.

FIG. 10 illustrates an example method performed by a background module.

The method begins with the background module 128 being initiated, at step 1000, by the credit module 126. In some embodiments, the background module 128 may be initiated once a renter 146 connects to the net lease network 102 and applies for a rental property. In some embodiments, the background module 128 may be initiated based on a time period, such as weekly, monthly, quarterly, yearly, etc., to continuously check the renter's 146 information from a plurality of 3rd party networks.

The background module 128 extracts, at step 1002, the renter 146 data from the renter database 132. For example, the background module 128 extracts the renter 146 data, such as their name, date of birth, birthplace, etc. In some embodiments, the renter 146 data may include previous places of residence.

The background module 128 connects, at step 1004, to the 3rd party criminal database network 154, the 3rd party employment verification network 156, and the 3rd party financial verification network 158. For example, the background module 128 connects to the 3rd party criminal database network 154, which may be a network connected to various criminal databases to determine an individual's criminal history. For example, the 3rd party criminal database network 154 may collect data about individuals from a national criminal records database, a statewide criminal record database, a county criminal record database, an FBI database, a sex offender registry, terrorist watch lists, etc.

The background module 128 connects to the 3rd party employment verification network 156, which may be a network for professional background screening firms and/or an employment verification service such as The Work Number® from Equifax. In some embodiments, the 3rd party employment verification network 156 may be a 3rd party service that reaches directly out to the renter's 146 or potential renter's 146 employers to confirm their employment history. The background module connects to the 3rd party financial verification network 158, which may be a network containing screening services to verify potential tenants or renters 146 financial records or income. In some embodiments, the income documents used to verify financial records or income may be pay stubs, tax returns, bank statements, employment letters, offer letters, etc. In some embodiments, the documents may include a list of investments or the renters 146 investment portfolios.

The background module 128 sends, at step 1006, the renter 146 data to the 3rd party criminal database network 154, the 3rd party employment verification network 156, and the 3rd party financial verification network 158. For example, the background module 128 sends the renter 146 data, such as their name, date of birth, birthplace, previous places of residence, etc., to the 3rd party criminal database network 154, the 3rd party employment verification network 156, and the 3rd party financial verification network 158.

Then the background module 128 receives, at step 1008, the data about the renter 146 from the 3rd party criminal database network 154, the 3rd party employment verification network 156, and the 3rd party financial verification network 158. For example, the background module 128 receives data related to the renter 146, such as their criminal history, employment verification, and financial verification. In some embodiments, the data may contain the renter's 146 criminal offenses or list of criminal history, if any. In some embodiments, the data may contain the means to verify the renter's 146 employment, such as a pay stub, direct contact with the employer, etc. In some embodiments, the renter's 146 financial verification may include the renter's 146 tax information, such as salary, investments, supplemental income, savings in bank accounts, amount of debt, etc.

The background module 128 determines, at step 1010, if the renter 146 has a criminal record. For example, the background module 128 determines from the data received from the 3rd party criminal database network 154 if the renter 146 has a criminal record. In some embodiments, the background module 128 may receive criminal offenses or a list of criminal history, if any.

If it is determined that the renter 146 has a criminal record, the background module 128 notifies, at step 1012, an administrator of the net lease network 102. For example, the background module 128 notifies an administrator of the net lease network 102 that the renter 146 has a criminal record, such as the offenses, history, etc. In some embodiments, the net lease network 102 may have a list of types of renters 146 they desire to offer rental agreements too, and if the renter 146 fails any part of the list, the renter 146 may be denied approval for a rental agreement.

If it is determined that the renter 146 does not have a criminal record or that the administrator of the net lease network 102 has already been notified, the background module 128 stores, at step 1014, the data in the renter database 132. In some embodiments, the database may contain the renter's 146 criminal offenses or list of criminal history, if any. The background module 128 determines, at step 1016, if the renter's 146 employment is verified. For example, the background module 128 determines from the data received from the 3rd party employment verification network 156 if the renter's 146 employment is verified. In some embodiments, the data may contain the means to verify the renter's 146 employment, such as a pay stub, direct contact with the employer, etc.

If it is determined that the renter's 146 employment is not verified, the background module 128 notifies, at step 1018, an administrator of the net lease network 102. For example, the background module 128 notifies an administrator of the net lease network 102 that the renter 146 does not have verified employment. In some embodiments, the net lease network 102 may have a list of types of renters 146 they desire to offer rental agreements too, and if the renter 146 fails any part of the list, the renter 146 may be denied approval for a rental agreement.

If it is determined that the renter 146 employment is verified or that the administrator of the net lease network 102 has already been notified, the background module 128 stores, at step 1020, the data in the renter database 132. In some embodiments, the data may contain the means to verify the renter's 146 employment, such as a pay stub, direct contact with the employer, etc.

Then the background module 128 determines, at step 1022, if the renter's 146 financials are verified. For example, the background module 128 determines from the data received from the 3rd party financial verification network 158 if the renter's 146 financials are verified. In some embodiments, the renter's 146 financial verification may include the renter's 146 tax information, such as salary, investments, supplemental income, savings in bank accounts, amount of debt, etc.

If it is determined that the renter's 146 financials are not verified, the background module 128 notifies, at step 1024, an administrator of the net lease network 102. For example, the background module 128 notifies an administrator of the net lease network 102 that the renter 146 does not have verified financial records. In some embodiments, the net lease network 102 may have a list of types of renters 146 they desire to offer rental agreements too, and if the renter 146 fails any part of the list, the renter 146 may be denied approval for a rental agreement.

If it is determined that the renter's 146 financials are verified or that the administrator of the net lease network 102 has already been notified, the background module 128 stores, at step 1026, the data in the renter database 132. In some embodiments, the renter's 146 financial verification may include the renter's 146 tax information, such as salary, investments, supplemental income, savings in bank accounts, amount of debt, etc. In some embodiments, if the renter 146 has been approved and verified for all the checks in the credit module 126 and background module 128, the renter 146 may be offered a rental agreement from the net lease network 102. In some embodiments, an administrator may review the data collected from a plurality of renter 146 candidates to determine which renter 146 will get the rental agreement.

Then the background module 128 initiates, at step 1028, the market module 130. For example, the market module 130 begins by being initiated by the background module 128. In some embodiments, the market module 130 may be initiated periodically, such as weekly, monthly, quarterly, yearly, etc. to determine the status of the renter's 146 financial stability to pay the rent. The market module 130 extracts the first renter 146 from the renter database 132. The market module 130 connects to the 3rd party labor statistics network 160. The market module 130 receives the labor statistic data from the 3rd party labor statistics network 160. The market module 130 compares the extracted renter 146 data from the renter database 132 to the received labor statistics data from the 3rd party labor statistics network 160.

The market module 130 determines if the renter 146 is currently in good standing. If it is determined that the renter 146 is not in good standing, the market module 130 connects to the 3rd party loan services network 162. The market module 130 sends the renter 146 data to the 3rd party loan services network 162. The market module 130 receives the estimated loan terms from the 3rd party loan services network 162 for the renter 146. The market module 130 sends the received loan terms from the 3rd party loan services network 162 to the renter 146. If it is determined that the renter 146 is in good standing, the market module 130 determines if there are more renters 146 remaining in the renter database 132. If it is determined that there are more renters 146 remaining in the renter database 132, the market module 130 extracts the next renter 146 from the renter database 132, and the method returns to connecting the 3rd party labor statistics network 160. If it is determined that there are no more renters 146 remaining in the renter database 132, the market module 130 returns to the net lease module 104.

FIG. 11 displays the market module 130. The method begins with the market module 130 being initiated, at step 1100, by the background module 128. In some embodiments, the market module 130 may be initiated periodically, such as weekly, monthly, quarterly, yearly, etc., to determine the status of the renter's 146 financial stability to pay the rent.

The market module 130 extracts, at step 1102, the first renter 146 from the renter database 132. For example, the background module 128 extracts the renter 146 data, such as their name, job title, what industry they work in, location of the rental property, etc.

The market module 130 connects, at step 1104, to the 3rd party labor statistics network 160. For example, the market module 130 connects to the 3rd party labor statistics network 160 through the cloud 150.

The market module 130 receives, at step 1106, the labor statistic data from the 3rd party labor statistics network 160. For example, the market module 130 receives data from the 3rd party labor statistics network 160, such as measurements of labor market activity, working conditions, price changes, productivity in the economy, etc.

The market module 130 compares, at step 1108, the extracted renter 146 data from the renter database 132 to the received labor statistics data from the 3rd party labor statistics network 160. For example, the market module 130 may compare the job title and/or industry that the renter 146 works in to determine if the renter's 146 industry or job is in danger, for example, by comparing unemployment rates from the previous year to the current year. In some embodiments, the market module 130 may compare the renter's 146 employment data to inflation rates to determine if the renter's 146 salary or wages are keeping up with current inflation rates. In some embodiments, the market module 130 may compare the renter's 146 location with unemployment rates, inflation rates, salaries or wages, etc., with others located in the same area to determine if they are in danger of financial instability.

The market module 130 determines, at step 1110, if the renter 146 is currently in good standing. For example, the market module 130 may determine if the renter 146 is in good standing by if the unemployment rate in their industry is below a predetermined threshold, such as 5%, if their salaries and wage increase year over year matches or exceeds inflation rates, or if the unemployment rate for the area is below a certain threshold, such as 5%. If the renter 146 does not achieve one or more of these requirements, then the market module 130 may determine that the renter 146 may benefit from having loan assistance to ensure payment of their rental payments.

If it is determined that the renter 146 is not in good standing, the market module 130 connects, at step 1112, to the 3rd party loan services network 162. For example, the market module 130 connects to a 3rd party loan service network 162, which may be a 3rd party that provides loans to renters 146 in a period of financial instability to ensure their rental payments. The 3rd party loan service network 162 may be a company that collects a borrower's interest, principal, and escrow payments.

The market module 130 sends, at step 1114, the renter 146 data to the 3rd party loan services network 162. For example, the market module 130 may send the renter data, such as the renter's 146 name, address, employment descriptions, salary or wages, etc., to the 3rd party loan services network 162 to receive an estimated loan offer from the 3rd party loan services network 162 for the renter 146.

The market module 130 receives, at step 1116, the estimated loan terms from the 3rd party loan services network 162 for the renter 146. For example, the market module 130 receives estimated loan terms for the renter 146 from the 3rd party loan services network 162.

The market module 130 sends, at step 1118, the received loan terms from the 3rd party loan services network 162 to the renter 146. For example, the market module 130 sends the received loan terms from the 3rd party loan services network 162 to the renter 146. In some embodiments, the renter 146 may decide not to accept the loan terms. In some embodiments, the net lease network 102 may adjust the rental agreement for the renter 146 if they face financial difficulties, such as adjusting payment terms for the remainder of the rental agreement by decreasing the payments in the short term but increasing the payments for future months.

If it is determined that the renter 146 is in good standing, the market module 130 determines, at step 1120, if there are more renters 146 remaining in the renter database 132.

If it is determined that there are more renters 146 remaining in the renter database 132, the market module 130 extracts, at step 1122, the next renter 146 from the renter database 132, and the method returns to connecting the 3rd party labor statistics network 160. If it is determined that there are no more renters 146 remaining in the renter database 132, the market module 130 returns, at step 1124, to the net lease module 104.

FIG. 12 shows an example system for implementing certain aspects of this disclosure of the present technology, which can be for example any computing device making up the net lease network 102 or the net lease system 100, or any component thereof in which the components of the system are in communication with each other using connection 2005. Connection 2005 can be a physical connection via a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that couples various system components including system memory 2015, such as read-only memory (ROM) 2020 and random access memory (RAM) 2025 to processor 2010. Computing system 2000 can include a cache of high-speed memory 2020 connected directly with, in close proximity to, or integrated as part of processor 2010.

Processor 2010 can include any general purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms known to those of skill in the art. In some instances, multimodal systems can enable a user to provide multiple types of input/output to communicate with computing system 2000. Computing system 2000 can include communications interface 2040, which can generally govern and manage the user input and system output. There is no restriction on operating on any particular hardware arrangement, and therefore the basic features here may easily be substituted for improved hardware or firmware arrangements as they are developed.

Storage device 2030 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function.

In some embodiments, the database may contain the renter's 146 salaries along with their job title. In some embodiments, the database may contain the renter's 146 credit score. In some embodiments, the database may contain the renter's 146 criminal offenses or list of criminal history, if any. In some embodiments, the database may contain the means to verify the renter's 146 employment, such as a pay stub, direct contact with the employer, etc. In some embodiments, the renter's 146 financial verification may include the renter's 146 tax information, such as salary, investments, supplemental income, savings in bank accounts, amount of debt, etc. In some embodiments, the renter's 146 status may be if they are applying to rent a property, currently are renting a property, if the renter is in good standing, such as they are up to date on payments, are not in danger of becoming unemployed, if they are in danger of facing financial instability due to employment issues or industry layoffs, if they are currently paying their rental payments with the assistance of a loan, etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of automating a residential net lease management tool with a credit enhancement module, comprising:
receiving, over an expense network, market data associated with a specific region sent over a communication network at a net lease management server configured to communicate with at least one third-party application;
initiating, by a net lease module, a reserve module;
generating, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiating, by the net lease module, an owner module;
identifying, by the owner module, properties that fall within the net lease parameters generated by the reserve module;
initiating, by the net lease module, a manage module;
determining, by the manage module, fixed costs and variable costs based on data associated with at least one of the identified properties and extracted data points from stored invoice data;
generating, by the reserve module, a set of net lease terms for a residential net lease tenant, wherein the set of net lease terms is associated with the at least one of the properties identified by the net lease module, based on inputs including the fixed costs and variable costs determined the manage module, wherein weights are assigned to each input;
initiating, by the net lease module, an enhancement module;
generating, by the enhancement module, one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios;
determining, by the enhancement module, that a backstop database to the single reserve database does not have a sufficient backstop amount to cover the multiplier of the predicted amount based on results of the stress scenario; and
sending, based upon the determination and over the communication network, an instruction to trigger a transfer of a difference between the sufficient backstop amount and an accounting at the backstop database to the backstop database.

2. The computer-implemented method of claim 1, further comprising:
using a machine-learning model to output the set of net lease terms, and wherein the machine-learning model determines the weights based on training data including past net lease terms associated with the one or more regions.

3. The computer-implemented method of claim 1, further comprising:
using a machine-learning model to initialize the one or more stress scenarios, wherein the machine-learning model selects the predicted amount between an upper bound and a lower bound and a multiplier between a multiplier upper bound and a multiplier lower bound based on weights set by training data including the extracted historical data.

4. The computer-implemented method of claim 3, further comprising:
retraining the machine-learning model with new extracted historical data;
using the retrained machine-learning model to initialize one or more new stress scenarios, wherein the machine-learning model selects a new predicted amount between a new upper bound and a new lower bound and a new multiplier between a new multiplier upper bound and a new multiplier lower bound based on new weights set by new training data including the new extracted historical data;
determining, by the enhancement module, that the backstop database to the single reserve database does not have a sufficient backstop amount to cover the multiplier of the predicted amount based on results of the stress scenario; and
sending, based upon the determination and over the communication network, an instruction to trigger a transfer of a difference between the sufficient backstop amount and an accounting at the backstop database to the backstop database.

5. The computer-implemented method of claim 1, further comprising:
determining, by the manage module, the fixed costs and the variable costs based on data associated with extracted data points from stored invoice data;
recording, by the accounting module in the single reserve database associated with the single reserve database, a third accounting for a third amount remunerated for the fixed costs based on the net lease terms stored at the lease database, wherein the fixed costs include at least one of property management, property taxes, property insurance, or property maintenance; and
recording, by the accounting module in the single reserve database associated with the single reserve database, a fourth accounting for a fourth amount remunerated to the respective owners and collected from respective tenants per a rent schedule based on the net lease terms stored at the lease database.

6. The computer-implemented method of claim 1, wherein based on the transfer, the residential net lease tenant is predicted to qualify for an investment grade tenant.

7. The computer-implemented method of claim 1, wherein the inputs include at least one of average rent in the one or more regions, square footage of the respective property, market growth rate, inflation rate, vacancy rate, rent collectability rate, home price appreciation, or operating expenses.

8. The computer-implemented method of claim 1, further comprising:
sending a notification to the identified one or more owners regarding the one or more properties; and
receiving an approval from one of the owners to generate a contractual agreement document associated with one of the properties.

9. The computer-implemented method of claim 1, further comprising:
receiving market data associated with a different region sent over the communication network at the net lease management server;
generating a second set of net lease parameters for the different region based on the calculated profitability evaluation that determines the respective threshold margin;
identifying one or more second owners with one or more second properties that fall within the second set of net lease parameters;
determining a second set of fixed costs and variable costs based on data associated with the one of the second properties and extracted data points from stored invoices of associated vendors; and
generating a second set of net lease terms associated with the one of the second properties based on the determined second set of fixed costs and variable costs, using a machine-learning algorithm that outputs the second set of net lease terms.

10. A system for automating a residential net lease management tool with an exchange module, comprising:
a storage configured to store instructions;
a net lease module that controls a reserve module, an owner module, a manage module, and an enhancement module;
the reserve module that generates a plurality of net lease parameters for different regions;
the owner module that identifies properties that fall within a particular net lease parameter;
the manage module that determines fixed costs and variable costs;
the enhancement module that generates stress scenarios; and
one or more processors configured to execute the instructions and cause the one or more processors to:
receiving, over an expense network, market data associated with a specific region sent over a communication network at a net lease management server configured to communicate with at least one third-party application;
initiating, by the net lease module, the reserve module;
generating, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiating, by the net lease module, the owner module;
identifying, by the owner module, properties that fall within the net lease parameters generated by the reserve module;
initiating, by the net lease module, the manage module;
determining, by the manage module, fixed costs and variable costs based on data associated with at least one of the identified properties and extracted data points from stored invoice data;
generating, by the reserve module, a set of net lease terms for a residential net lease tenant, wherein the set of net lease terms is associated with the at least one of the properties identified by the net lease module, based on inputs including the fixed costs and variable costs determined the manage module, wherein weights are assigned to each input;
initiating, by the net lease module, the enhancement module;
generating, by the enhancement module, one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios;
determining, by the enhancement module, that a backstop database to the single reserve database does not have a sufficient backstop amount to cover the multiplier of the predicted amount based on results of the stress scenario; and
sending, based upon the determination and over the communication network, an instruction to trigger a transfer of a difference between the sufficient backstop amount and an accounting at the backstop database to the backstop database.

11. The system of claim 10, wherein the processor is configured to execute the instructions and cause the one or more processors to:
using a machine-learning model to output the set of net lease terms, and wherein the machine-learning model determines the weights based on training data including past net lease terms associated with the one or more regions.

12. The system of claim 10, wherein the processor is configured to execute the instructions and cause the one or more processors to:
using a machine-learning model to initialize the one or more stress scenarios, wherein the machine-learning model selects the predicted amount between an upper bound and a lower bound and a multiplier between a multiplier upper bound and a multiplier lower bound based on weights set by training data including the extracted historical data.

13. The system of claim 12, wherein the processor is configured to execute the instructions and cause the one or more processors to:
retraining the machine-learning model with new extracted historical data;
using the retrained machine-learning model to initialize one or more new stress scenarios, wherein the machine-learning model selects a new predicted amount between a new upper bound and a new lower bound and a new multiplier between a new multiplier upper bound and a new multiplier lower bound based on new weights set by new training data including the new extracted historical data;
determining, by the enhancement module, that the backstop database to the single reserve database does not have a sufficient backstop amount to cover the multiplier of the predicted amount based on results of the stress scenario; and
sending, based upon the determination and over the communication network, an instruction to trigger a transfer of a difference between the sufficient backstop amount and an accounting at the backstop database to the backstop database.

14. The system of claim 10, wherein based on the transfer, the residential net lease tenant is predicted to qualify for an investment grade tenant.

15. The system of claim 10, wherein the inputs include at least one of average rent in the one or more regions, square footage of the respective property, market growth rate, inflation rate, vacancy rate, rent collectability rate, home price appreciation, or operating expenses.

16. The system of claim 10, wherein the one or more processors is configured to execute the instructions and cause the one or more processors to:
send a notification to the identified one or more owners regarding the one or more properties; and
receive an approval from one of the owners to generate a contractual agreement document associated with one of the properties.

17. The system of claim 10, wherein the one or more processors is configured to execute the instructions and cause the one or more processors to:
receive market data associated with a different region sent over the communication network at the net lease management server;
generate a second set of net lease parameters for the different region based on the calculated profitability evaluation that determines the respective threshold margin;
identify one or more second owners with one or more second properties that fall within the second set of net lease parameters;
determine a second set of fixed costs and variable costs based on data associated with the one of the second properties and extracted data points from stored invoices of associated vendors; and
generate a second set of net lease terms associated with the one of the second properties based on the determined second set of fixed costs and variable costs, use a machine-learning algorithm that outputs the second set of net lease terms.

18. A non-transitory computer readable medium comprising instructions, the instructions, when executed by a computing system, cause the computing system to:
generate, by a reserve module, net lease parameters for a specific region based on a calculated profitability evaluation based on market data received via an expense network, wherein the calculated profitability evaluation determines a threshold margin based on a percentage of an average rental rate and average fixed costs in the specific region;
initiate, by a net lease module, an owner module;
identify, by the owner module, properties that fall within the net lease parameters generated by the reserve module;
generate, by the reserve module, a set of net lease terms for a residential net lease tenant, wherein the set of net lease terms is associated with the at least one of the properties identified by the net lease module, based on inputs including fixed costs and variable costs determined based on data associated with at least one of the identified properties and extracted data points from stored invoice data, wherein weights are assigned to each input;
initiate, by the net lease module, an enhancement module;
generate, by the enhancement module, one or more stress scenarios based on the net lease terms, extracted historical trend data that impact the fixed costs and variable costs from an expenses database, and an accounting at a single reserve database, wherein the one or more stress scenarios selects a multiplier and a predicted amount for future expenses based on the historical data in varied scenarios;
determine, by the enhancement module, that a backstop database to the single reserve database does not have a sufficient backstop amount to cover the multiplier of the predicted amount based on results of the stress scenario; and
send, based upon the determination and over a communication network, an instruction to trigger a transfer of a difference between the sufficient backstop amount and an accounting at the backstop database to the backstop database.

19. The computer readable medium of claim 18, wherein the computer readable medium further comprises instructions that, when executed by the computing system, cause the computing system to:
using a machine-learning model to output the set of net lease terms, and wherein the machine-learning model determines the weights based on training data including past net lease terms associated with the one or more regions.

20. The computer readable medium of claim 19, wherein the computer readable medium further comprises instructions that, when executed by the computing system, cause the computing system to:
using a machine-learning model to initialize the one or more stress scenarios, wherein the machine-learning model selects the predicted amount between an upper bound and a lower bound and a multiplier between a multiplier upper bound and a multiplier lower bound based on weights set by training data including the extracted historical data.
